(19) United States
(12) Patent Application Publication
(10) Pub. No.: US 2007/0254063 A1
(43) Pub. Date: Nov. 1, 2007

(54) USE OF HOP POLYPHENOLS IN BEER

(75) Inventors: Guido Aerts, Lovendegem (BE); Luc De Cooman, De Pinte (BE); Gert De Rouck, Herzele (BE); Koen Goiris, Oostakker (BE)

Correspondence Address: CLARK & ELBING LLP, 101 FEDERAL STREET, BOSTON, MA, 02110, US

(73) Assignee: CHEMISCH EN BIOCHEMISCH ONDERZOEKSCENTRUM (CBOK), Gent (BE)

(21) Appl. No.: 11/697,557

(22) Filed: Apr. 6, 2007

Related U.S. Application Data
(60) Provisional application No. 60/789,915, filed on Apr. 7, 2006.

(30) Foreign Application Priority Data
May 1, 2006 (CA) 2,544,488

(51) Int. Cl. C12C 11/00

(52) U.S. Cl. 426/11

(57) ABSTRACT

The present invention relates to a new method for brewing beer comprising the addition of polyphenol-rich extracts prepared from hops at specific steps during or after the brewing process. The method enhances the mouthfeel, the reducing power and the stability of beer. Furthermore, beers comprising the polyphenol-rich extracts are provided.

### CROSS-REFERENCE TO RELATED APPLICATIONS

This application claims priority from U.S. Provisional Patent Application Ser. No. 60/789,915 and Canadian Patent Application Serial No. 2,544,488 filed respectively on Apr. 7, 2006 and May 1, 2006; the contents of each of which are incorporated herein by reference.

### FIELD OF THE INVENTION

The present invention relates to a new method for brewing beer comprising the addition of polyphenol-rich extracts prepared from hops at specific steps during or after the brewing process. The method enhances the mouthfeel, the reducing power and the stability of beer. Furthermore, beers comprising the polyphenol-rich extracts are provided.

### BACKGROUND OF THE INVENTION

The female flowers of the dioecious hop plant (Humulus lupulus L.), called hop cones or hops, are used since centuries to add flavor, aroma, bitterness, and antimicrobial activity to cereal-based beverages such as beer. In the traditional brewing method, whole hop cones are added at the onset of wort boiling so that the active hop constituents, in particular the precursors of bitter compounds, get extracted in the brew. For some types of ales, whole hops are also added during fermentation or post-fermentation to impart a so-called dry hop aroma to the finished beverage. Brewers can vary the amount of bitterness and the intensity and quality of hoppy aroma and flavor by varying the varieties of hops used, the amount of hops used and the point(s) of addition in the brewing process.

The chemical basis of hop bitterness, flavor and aroma is believed to be attributable to three main groups of secondary metabolites: the hop acids, the hop essential oils, and the non-polyphenolic hop glycosides. The hop acids and hop essential oils are produced by glands in the petals of hop cones, which exude a sticky resin known as lupulin.

The hop acids, also called soft resins, consist of two groups: the alpha-acids or humulones and beta-acids or lupulones (De Keukeleire, 2000). Together they represent up to 25% of the dry weight of hop cones. Hop acids have strong bacteriostatic activity, a property by which they impart to wort and beer antimicrobial activity, in particular against Gram-positive bacteria. During wort boiling, alpha-acids are isomerised to iso-alpha-acids or isohumulones, which are intensely bitter. The beta-acids show a very low solubility in wort and, consequently, they are largely precipitated during wort boiling. Beta-acids are much less critical to beer bitterness than the alpha-acids.

The hop essential oils contribute to the hoppy aroma of beer (Moir, 2000). They are present at 0.5-3% (v/v) of the hop cone dry weight and consist of a large group of diverse small volatile compounds, including monoterpenes (e.g. myrcene), diterpenes (e.g. dimyrcene), sesquiterpenes (e.g. α-humulene, β-caryophyllene, limonene), monoterpene alcohols and sesquiterpene alcohols (e.g. linalool, geraniol, citronellol, humulenol), oxygenated sesquiterpenoids (e.g. humulene-1,2-epoxide, caryophyllene epoxide, humuladienone), esters (e.g. 2-methylpropyl isobutyrate, geranyl acetate), and organosulphur compounds (e.g. 1,2-epithiohumulene).

The non-polyphenolic hop glycosides have recently been found to contribute to the hoppy flavor, in particular the desirable kettle hop flavor and taste, but not to the aroma of hops as such (US 2003/0138546). They consist of glycosides (e.g. glucosides, arabinoglucosides) of alcohols (e.g. hexanol, octanol), monoterpene alcohols (e.g. linalool, geraniol, α-terpineol), or ketones (e.g. raspberry ketone, grasshopper ketone). When the glycosidic bonds are hydrolysed, e.g. during primary fermentation or subsequent lagering, the non-polyphenolic aglycones are released and contribute to kettle hop flavor. In addition, the unmodified non-polyphenolic glycosides do not impart aroma but they contribute to the kettle hop taste.

The polyphenols in hop cones consist of diverse classes of which proanthocyanidins, monomeric flavanols, flavonol glycosides, and prenylated flavonoids are the major ones and hydroxybenzoic acids, hydroxycinnamic acids, and flavonols are minor classes. Together they represent about 4 to 6% (w/w) of the hop dry weight. The role of hop polyphenols in the organoleptic properties of beer is a matter of controversy. The dominating view is that polyphenols have no important contribution to the flavor of beer (Delcour et al. 1984; Delcour et al. 1985; McMurrough and Delcour 1994; US 2003/0138546). This has been confirmed in an experiment whereby hop polyphenols were removed from a preparation of non-polyphenolic glycosides by adsorption to polyvinylpolypyrrolidone (PVPP), which caused no perceivable reduction of the flavoring effect (US 2003/0138546). Forster et al (1995) claim that hop polyphenols on the one hand have a positive influence on beer taste, but on the other hand also cause an unpleasant bitterness when present in high concentrations.

The use of whole hops as a raw material in brewing suffers from a number of drawbacks. The paramount problem is that the amount of aromatic and flavoring constituents in hops varies considerably from batch to batch according to the climatic and soil conditions prevailing during hop cultivation, the harvest time, the time elapsed between harvesting and drying, as well as the drying and storage conditions. Therefore, the use of whole hops during brewing is inappropriate for delivering a final product with consistent sensory qualities. Moreover, during wort boiling several undesired compounds are extracted from whole hops, including pesticides, nitrates (causing formation of carcinogenic nitrosamines), heavy metals and iron (favoring colloidal haze and oxidation of lipids to produce ill-tasting unsaturated aldehydes), radionuclides, hard resins, deteriorated resins, lipids and waxes.

Hops can also be added as hop powder pellets. Hop powder pellets are prepared by removing foreign material from hop cones, milling the whole hops to powder in a hammer mill, blending to standardize the amount of bitter compounds, pelleting through a pellet mill, cooling and packing. The major advantages of hop powder pellets over whole hops relate to volume reduction, standardization and consistency of the flavoring compounds, greater storage stability, and the shorter boiling times required to extract and generate bitter flavor. On the other hand, the use of pellets generates less of desirable hoppy aroma in beer compared to whole hops, due to volatilization of essential oils from mechanically ruptured cone glands. Hop pellets have the same drawback as whole hops with respect to extraction of undesired compounds.

Several types of standardized hop extracts are nowadays commercially available. In general, hop extracts have the advantage over whole hops and hop pellets to take little volume, to be storable over a longer period of time, to lead to a more consistent flavoring of beer, and to avoid the introduction of undesirable hop constituents in beer.

The predominant hop extracts on the market today are extracts that consist mainly of hop acids. Extraction of hop acids involves milling, pelleting and re-milling the hops to spread the lupulin, passing a solvent through a packed column to collect the resin components, and finally, removal of the solvent. The most widely used solvent is either liquid CO₂ (typically at 60 bar pressure and 5-10° C.) or supercritical CO₂ (typically at 300 bar pressure and at 60° C). Non-polar organic solvents such as hexane are increasingly falling out of favor due to perceived problems with the residues. The use of methanol as a solvent for extraction of hops (U.S. Pat. No. 2,824,803) is fully abandoned nowadays, and ethanol has been largely abandoned as well because of the relatively low efficiency of extraction of hop acids by alcohols as compared to CO₂. Liquid and supercritical CO₂ extract efficiently and quite selectively the hop acids (soft resins) and hop essential oils from hops, and such CO₂ extracts contain virtually none of the hard resins, tannins, waxes, polyphenols, non-polyphenolic glycosides, and water soluble minerals such as nitrates. CO₂ extracts are called “whole pure resin extracts” and are typically added at the onset of wort boiling to allow isomerisation of the hop alpha-acids at high temperature.

Whole pure resin extracts can be further processed by heating and/or chemical treatment to isomerise the alpha acids into the bitter iso-alpha-acids or isohumulones. Such extracts are called “isomerised kettle extracts” because they still need to be added to the kettle, i.e. during wort boiling.

A further step in hop processing can be the purification of isohumulones from isomerised kettle extract, or, alternatively, alpha acids can be isolated from whole pure resin extract followed by isomerisation to yield isohumulones. The extracts thus obtained are called “isomerised alpha-acid extracts”. The purified isohumulones can be further modified by chemical treatment to yield reduced isohumulones such as dihydroisohumulones, tetrahydroisohumulones or hexahydroisohumulones. Reduced isohumulones were originally developed for their lightproof properties but nowadays they are also widely applied because of their foam stabilizing properties and positive effects on cling or lacing.

Extracts consisting mainly of “hop essential oils” or “hop essences” are also commercially available. The hop essential oil extracts are produced starting from CO₂ extracts, preferably from liquid CO₂ extracts since the gentle extraction conditions leave the essential oils relatively unchanged. The hop essential oils in CO₂ extracts are separated from the hop acids using for instance a vacuum distillation procedure. Such hop oil extracts can be either produced from a specific hop variety or from different varieties, which can be blended to obtain a generic oil that is highly consistent from batch to batch and year to year. The hop essential oils can be further separated by chromatographic procedures into fractions that impart to beer either spicy aromas (enriched in oxygenated sesquiterpenoids), floral aromas (enriched in monoterpene alcohol esters), citrus aromas (enriched in monoterpene alcohols), or dry hop aromas (enriched in terpenoids and sesquiterpenoids) (Chapman 1988, De Cooman et al. 2004). Such hop essential oil extracts are typically added post-fermentation during the brewing process to increase the overall hop aroma character of beers or to provide a distinctive spicy, dry hoppy, citrussy, piney, or florally note.

An extract rich in non-polyphenolic glycosides from hops has been described in US 2003/0138546. This extract is prepared by extraction of spent hops, the hop residue left over after CO₂ extraction, with aqueous ethanol followed by adsorption on an Amberlite XAD-2 column and elution with ethanol. The XAD2-fraction is used to add a kettle hop flavor and taste to beer. This extract also contains some polyphenols i.e. the flavonol glycosides kaempferol glucoside, kaempferol rutinoside, quercetin glucoside, and quercetin rutinoside, yet it does not contain the full spectrum of polyphenols. Furthermore, removal of the polyphenolic glycosides from the XAD2 fraction by treatment with PVPP (polyvinylpolypyrollidone) did not alter the flavoring potential of the XAD2-fraction. Thus, the PVPP treated extract (without the polyphenols) still contributed significantly to the kettle hop flavor in the fermentation product (US 2003/0138546).

In modern brewing, hop extracts are used increasingly at the detriment of whole hops or hop pellets. Whole pure resin extract can be used either in combination with whole hops or hop pellets, or used alone without whole hops or hop pellets. The advantages of the use of a CO₂-based whole pure resin extract over whole hops and hop pellets were mentioned above (higher bulk density, better stability of bittering substances on storage, homogenous product, more reproducible bitterness, lower levels of undesirable hop constituents introduced into beer, reduced wort losses). Alternatively, non-reduced or reduced isomerised hop alpha-acids can be used in conjunction with hop essential oils, a combination which is often described as “advanced hopping”. This relatively new technology has all of the advantages mentioned above for the whole pure resin extracts and has the additional benefit of providing highly consistent beer flavoring in terms of both bitterness and hoppy aroma. However, since none of the above described commercially available hop extracts contain substantial amounts of hop polyphenols, both conventional hopping using whole pure resin extract and advanced hopping using non-reduced or reduced isomerised hop alpha-acid extracts plus hop essential oil preparations, produce beers with a very low concentration of hop polyphenols or no hop polyphenols at all.

Polyphenols are generally considered to be a nuisance factor by brewers, as they are well known to promote colloidal instability (also called physical instability) through the formation of complexes with proteins, thus leading to reversible and ultimately irreversible turbidity or haziness in beer (Forster et al 1995; McMurrough et al 1996; Stewart 2004). In fact during brewing, efforts are undertaken to reduce the dosage of polyphenols e.g. by using specially cultivated varieties of barley free of proanthocyanidins (e.g. barley cultivars Caminant and Galant) or by using hop extracts free of polyphenols. Furthermore, in view of colloidal stabilization, polyphenols are often partly removed from finished beer by adsorption on polyvinylpolypyrrolidon (PVPP) during filtration. These efforts undertaken by brewers to minimize the polyphenol content in beer are in line with the general trend toward clear beers.

Polyphenols may have positive effects as well. A vast amount of data support the idea that health benefits associated with fruits, vegetables and red wine, including antitumor activities, are linked to the well known antioxidant activity of the polyphenols they contain (Urquiaga and Leighton 2000; Kanadaswami et al 2005; WO00/47062; U.S. Pat. No. 5,780,060). Furthermore, it has been demonstrated that addition to wine of proanthocyanidins extracted from oak increases the mouthfeel and body of wine, while addition of such proanthocyanidins to brandy enhanced the smoothness of the brandy taste (US20020001651). The effects of polyphenols observed on the flavor of beverages appear to be dependent on the source of the polyphenols: addition to wine of polyphenols extracted from cocoa decreased the perception of alcohol, while addition of a polyphenol extracted from pine increased alcohol perception (US20020001651). Hence, the effects of polyphenols on the flavor of a particular type of beverage appear to be real but nonetheless largely unpredictable and dependent on the type and origin of the polyphenols used.

Forster et al. (1995) have attempted to exploit some of the potential advantages of hop polyphenols in brewing by using a hop bracteole-enriched fraction rich in hop polyphenols, which was derived from the mechanical separation of the vegetative hop cone bracteoles from the lupulin glands during the preparation of lupulin-enriched hop pellets (T45 pellets). They found that beers to which this polyphenol-rich bracteole fraction was added during wort boiling had an increased polyphenol level, a higher reducing power and a more pleasant taste when compared with a reference beer prepared without the bracteole fraction. On the other hand, two drawbacks became apparent in the beers brewed with addition of the polyphenol-rich bracteole fraction during wort boiling: these beers had a significantly higher nitrate level than the reference beer prepared without the bracteole fraction, and, in addition, the polyphenol-supplemented beers were more turbid and thus had a lower colloidal stability.

Recently, interest has risen in particular types of hop polyphenols, such as the prenylated flavonoids (mainly xanthohumol, desmethylxanthohumol, and their derivatives isoxanthohumol, 6-prenyinaringenin and 8-prenyinaringenin). This interest is triggered by the anti-carcinogenous, anti-inflammatory and oestrogenic properties of prenylated flavanoids (Gerhauser et al 2002; Milligan et al. 2002). Several methods have been described in the prior art aimed at the extraction from hops of prenylated flavonoids, xanthohumol in particular (WO03014287, DE19939350, EP1424385, WO2005092353). All the above mentioned methods are well suited to extract prenylated flavonoids, which are less polar than the other hop polyphenols such as proanthocyanidins, flavanols and flavonol glycosides, yet are unsatisfactory for providing the full spectrum of hop polyphenols or for providing particular fractions of more polar hop polyphenols such as flavanols and flavonol glycosides. Although xanthohumol extracts are primarily used in pharmaceutical preparations, the production of beers with elevated concentrations of xanthohumol through addition of such xanthohumol extracts has been described (DE10256166, DE10320250).

Flavonol glycosides, such as rutin (quercetin-rhamnosyl-glucoside), are also of interest because of their demonstrated anti-oxidant and anti-carcinogenic properties (Molnar et al 1981; Dedoussis et al. 2005). JP09002917 describes a method for the production of a pharmaceutical preparation of a hop extract enriched in the flavanol catechin and the flavonol glycosides rutin (quercetin-rhamnosyl-glucoside) and quercitrin (quercetin-3-rhamnoside) has been described.

### SUMMARY OF THE INVENTION

The present invention relates to a novel polyphenol-rich brewing additive and the use thereof to produce beers having an improved mouthfeel, the reducing power and storage stability. In a particular embodiment the brewing additive of the present invention is used to produce low-calorie and/or low alcohol beers.

### DETAILED DESCRIPTION

List of Figures

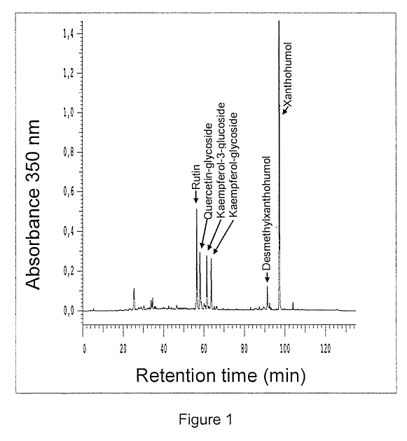

FIG. 1: HPLC-UV profile recorded by absorbance at 350 nm of the total hop polyphenol extract from spent hops of cv Saaz. Peaks corresponding to known compounds are indicated by the name of the corresponding compound.

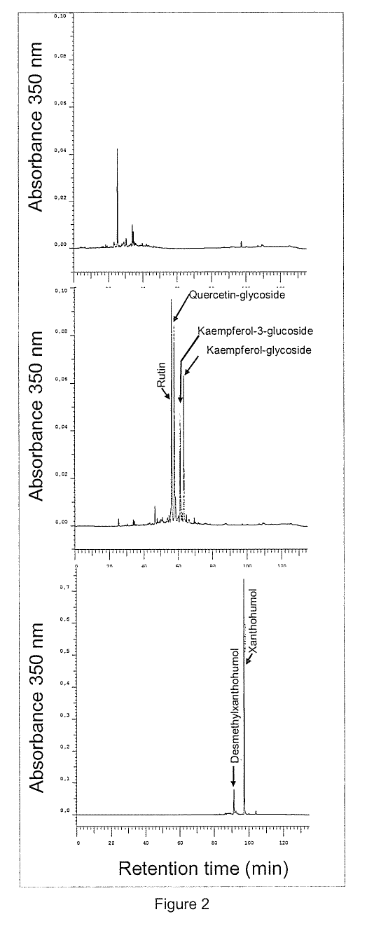

FIG. 2: HPLC-UV profiles recorded by absorbance at 350 nm of purified hop polyphenol fractions from cv Saaz. Top panel: hop proanthocyanidin fraction; middle panel: hop flavonol glycoside fraction; bottom panel: hop prenylated flavonoid fraction. Peaks corresponding to known compounds are indicated by the name of the corresponding compound.

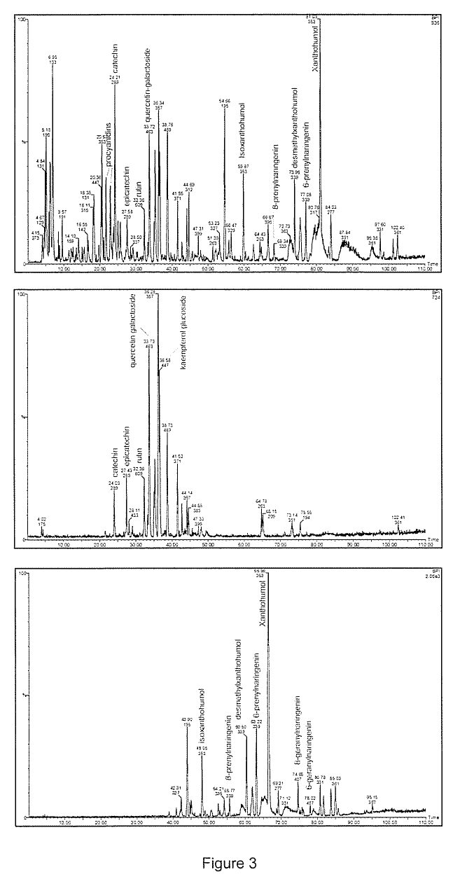

FIG. 3: LC-MS analysis of purified hop polyphenol fractions from cv Saaz. Profiles represent base peak intensity traces in ESI-MS mode. Top panel: total hop polyphenol extract; middle panel: hop flavonol glycoside fraction; bottom panel: hop prenylated flavonoid fraction. Peaks corresponding to known compounds are indicated by the name of the corresponding compound.

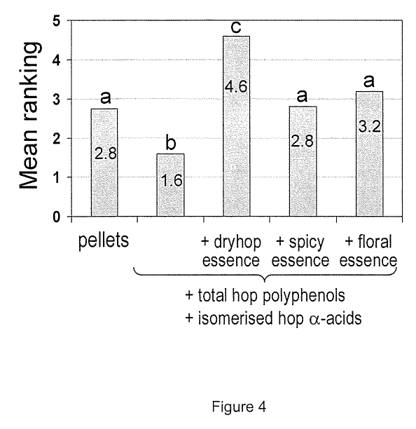

FIG. 4: Mean sensory ranking scores of the different experimental fresh top fermented beers hopped either with hop T45 pellets, or with different combinations of total hop polyphenol extract, isomerised hop alpha-acid extract and hop essences (spicy hop essence, floral hop essence, or dry hop essence). Sensory evaluation was performed with a trained panel of 18 persons. Ranking scores ranged from 1 (least preferred) to 5 (most preferred). Bars marked with a different letter are significantly different from each other according to Friedman's rank sum test at p<0.001.

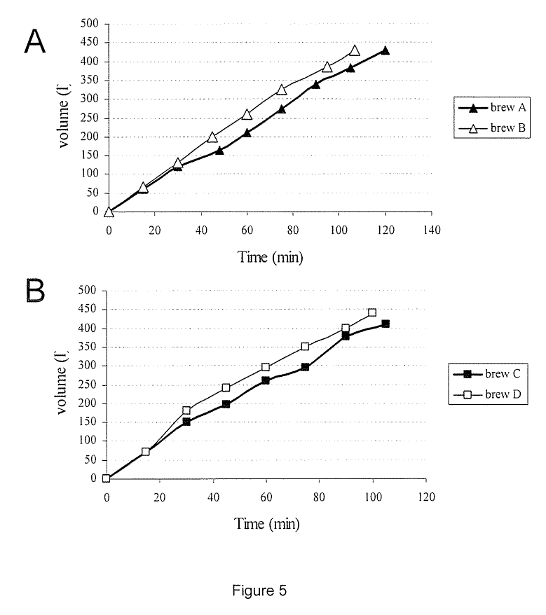

FIG. 5: Run-off rates during filtration in the lauter tun of brews A1/A2 and B1/B2 (panel A) and of brews C1/C2, and D1/D2 (panel B) prepared as described in the Materials and Methods of Example 3.

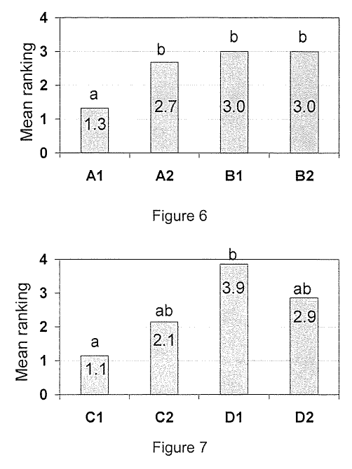

FIG. 6: Mean sensory ranking scores of the different experimental fresh pilsner beers A1, A2, B1, B2 prepared as described in the Materials and Methods of Example 3. Sensory evaluation was performed with a trained panel of 6 persons. Ranking scores ranged from 1 (least preferred) to 4 (most preferred). Bars marked with a different letter are significantly different from each other according to Friedman's rank sum test at p<0.10.

FIG. 7: Mean sensory ranking scores of the different experimental fresh pilsner beers C1, C2, D1, D2, prepared as described in the Materials and Methods of Example 3. Sensory evaluation was performed with a trained panel of 6 persons. Ranking scores ranged from 1 (least preferred) to 4 (most preferred). Bars marked with a different letter are significantly different from each other according to Friedman's rank sum test at p<0.001.

FIG. 8: Mean sensory ageing scores of beers A1, A2, B1, B2 prepared as described in the Materials and Methods in Example 3 after forced ageing for 5 days at 40° C. Ageing scores ranged from 0 (fresh) to 5 (very strongly aged, undrinkable). Sensory evaluation was performed with a trained panel of 6 persons. Bars marked with a different letter are significantly different from each other according to Friedman's rank sum test at p<0.05.

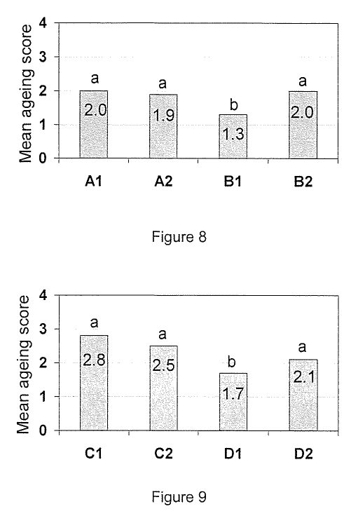

FIG. 9: Mean sensory ageing scores of beers C1, C2, D1, D2 prepared as described in the Materials and Methods in Example 3 after forced ageing for 5 days at 40° C. Ageing scores ranged from 0 (fresh) to 5 (very strongly aged, undrinkable). Sensory evaluation was performed with a trained panel of 7 persons. Bars marked with a different letter are significantly different from each other according to Friedman's rank sum test at p<0.05.

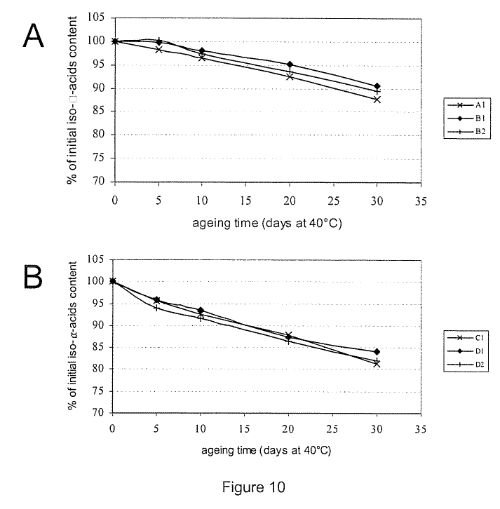

FIG. 10: Decay of iso-alpha-acids during forced ageing at 40° C. of beers A1, B1, B2 (panel A), and C1, D1, D2 (panel B) prepared as described in the Materials and Methods in Example 3.

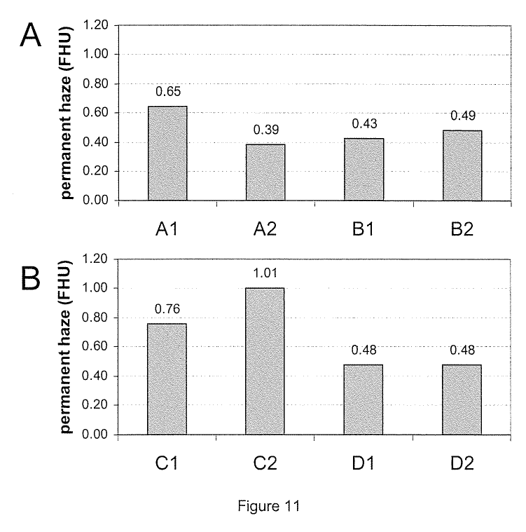

FIG. 11: Formation of permanent haze on forced ageing at 40° C. as a measure for colloidal stability of the different experimental brews A1, A2, B1, B2 (panel A), and of beers C1, C2, D1, and D2 (panel B) prepared as described in the Materials and Methods of Example 3.

### DESCRIPTION

Despite the well known antioxidant and health promoting properties of plant polyphenols in general, polyphenols from hops and their potential contribution to flavor in beer has so far received little attention in the prior art. The main reason for this is that hop polyphenols are associated with undesired properties such as colloidal instability and haze formation in beer (McMurrough et al. 1996; Stewart 2004), to the extent that modern brewing methods are focused on the elimination of polyphenols rather than on the deliberate addition of these substances during the brewing process (Bamforth 2000; Stewart 2004). The present invention is based on the finding that the addition to the beer of selected hop polyphenol preparations had a positive effect on the taste of said beers.

In a first object the present invention provides a brewing additive comprising a hop extract enriched in hop polyphenols and more particularly in flavonol glycosides. In a preferred embodiment more than 15% (w:w), of the total dry weight of such brewing additive are flavonol glycosides. Typically, such preferred brewing additive comprises the flavonol glycoside, rutin (quercetin-rhamnosyl-glucoside), in an amount corresponding to at least 5% (w:w) of the total dry weight of said additive. In a more preferred embodiment more than 30% (w:w), of the total dry weight of such brewing additive are flavonol glycosides. Typically, such more preferred brewing additive comprises the flavonol glycoside, rutin, in an amount corresponding to at least 10% (w:w) of the total dry weight of said additive. The brewing additive of the present invention may further comprise polyphenols other than flavonol glycosides, preferably at least 20% (w/w), more preferably at least 40%, for instance at least 50% of the dry matter comprised in said brewing additive are polyphenols, preferably hop polyphenols.

The present invention further provides a method for obtaining a brewing additive according to the present invention. In a preferred embodiment the brewing additive is produced by extracting hop cone material with an aqueous ethanol solvent of which the ratio of ethanol to water is lower than 20:1 and higher than 1:10 (v/v), most preferably between 4:1 and 1:4 (v/v). It is preferred that the ratio of hop material (on an air-dried weight basis) to the aqueous ethanol solvent is 1:1 to 1:200 (w/v). Optionally, the aqueous ethanol extract obtained from the hop material is counter-extracted with a non-polar solvent such as hexane, CO₂ (liquid or supercritical), chloroform, methylene chloride, toluene, benzene, petroleum ether or diethyl ether, with retention of the aqueous phase. The method can include the further step of concentration of the aqueous ethanol solvent extract, preferably by evaporation under reduced atmospheric pressure, to increase the concentration of the polyphenols in the extract. In a particular embodiment the extraction of said hop material is followed by a further purification of said extract using liquid chromatography with a polymeric resin derivatised with hydrophobic side chains and as a liquid phase water, ethanol or a mixture of water and ethanol. In a particular embodiment said aqueous ethanol extract is prepared using so called spent hops, which comprise the residue obtained after the extraction of hop material with a non-polar solvent, such as liquid or supercritical carbon dioxide. In another particular embodiment the brewing additive is produced using the vegetative waste material of lupulin-enriched hop cone pellet preparations, such as so-called T45 pellets.

In a second object the present invention provides beers to which the brewing additive of the present invention is added, resulting in increased levels of hop polyphenols in the beer. Preferably, the beers of the present invention comprise an amount of said extracts corresponding to an addition of 0.5 to 200 mg of polyphenols per liter, more preferably of 1 to 50 mg per liter. In a more preferred embodiment the beers of the present invention comprise an alcohol level below 3.5% (v/v) or a real extract below 3 g per 100 ml. In a particular preferred embodiment, said beer is a so-called low alcohol or alcohol free beer comprising less than 3.5% (v/v) alcohol, more preferably less than 1.5% (v/v) alcohol. In another preferred embodiment said beer is a so-called low calorie beer comprising less than 3 g per 100 ml real extract, more preferably less than 2 g per 100 ml.

In a third object the present invention provides a method for brewing beer, comprising the addition during or after the brewing process of a brewing additive according to the first object of the present invention in order to improve the mouthfeel, fullness in particular, of the finished beer and to impart particularly desirable organoleptic sensations without undesired astringency or stickiness. Preferably, the addition of the addition of said brewing additive corresponds to the addition of 0.5 to 200 mg of polyphenols per liter finished beer, more preferably of 1 to 50 mg per liter. In a preferred embodiment the brewing method of the present invention further comprises the addition during or after the brewing process of an extract enriched in hop acids. Preferably, about 5 to 125 mg purified isomerised or chemically modified isomerised hop alpha acids or 10 to 250 mg hop alpha acids are added per liter finished beer. In a more preferred embodiment of the present invention, the brewing method comprises the addition during or after the brewing process of i) the brewing additive of the present invention, ii) an extract enriched in hop acids or purified isomerised or chemically modified isomerised hop alpha acids, and of iii) a hop essential oil extract. Preferably, about 5 to 5000 μg essential hop oils are added per liter finished beer.

Light beers and low alcohol beers generally suffer from a poor mouthfeel. Hence the method of the present invention for increasing mouthfeel of beers by addition of a hop extract enriched in hop polyphenols is particularly useful for low calorie beers and low alcohol beers. The thus obtained low calorie beer or low alcohol beer has a taste resembling that of regular beers while maintaining its benefits of having a low calorie and/or low alcohol content. Low calorie beers and low alcohol beers are more susceptible to haze formation than stronger beers, because their low alcohol content favors colloidal instability. Moreover, due to the low solute content of such beers, off-taste formed during brewing and upon ageing is less masked as compared to regular beers. Hence the method of the present invention for improving colloidal and flavor stability of beer is particularly useful for low calorie beers and low alcohol beers.

In a fourth object the present invention provides a brewing method comprising the addition of a hop extract enriched in hop polyphenols to the mash or the brewing liquor used at the onset of mashing. The hop extract preferably comprises at least an amount of hop polyphenols corresponding to 15% of the total dry weight of the extract. More preferably the hop extract is a brewing additive according to the present invention. Preferably the addition of the hop extract to the mash or the brewing liquor used at the onset of mashing corresponds to the addition of 0.5 to 200 mg of polyphenols per liter finished beer, more preferably of 1 to 50 mg per liter. The presence of the hop polyphenols during the mashing resulted in the unexpected improvement of the brewing process and the resulting beer with respect to the following:
The duration of lautering was reduced.
With regard to the formation of permanent haze on storage, the colloidal stability of the finished beer was improved.
The flavor stability of the finished beer was improved and the finished beer showed less formation of ageing-related off-taste.
The reducing power of the finished beer was increased.
The mouthfeel, in particular the fullness of the finished beer was increased, resulting in an overall more pleasant taste sensation.

In the present invention, the term “flavor” is used to indicate the property of a compound or mixture of compounds that leads to olfactory, gustatory and tactile perception through nose and mouth. The term “aroma” designates the property of a compound or mixture of compounds that leads to perception by stimulation of the olfactory nerve through the retronasal route upon ingestion of the compound. The term “smell” is used to indicate the property of a volatile component or a mixture of volatile components that leads to perception by stimulation of the olfactory nerve through the nose. The term “mouthfeel”, is used to depict the carbonation, fullness and afterfeel of a beer where these descriptors are used to describe the textural attributes that are responsible for producing characteristic tactile sensations on the surface of the oral cavity (Langstaff 1993).

In the present invention, the term “beer” refers to a beverage, preferably a fermented or yeast contacted beverage, made from cereal grains, preferably barley, wheat, triticale, oat, rye, maize, sorghum, millet or rice, or milled cereals or malt produced from such cereal grains. The term beer as used herein is meant to include without limitation ale, strong ale, mid ale, bitter ale, pale ale, sour ale, stout, porter, lager, malt liquor, barley wine, happoushu, bock, doppelbock, Kölsch beer, Münchener beer, Dortmunder beer, Düsseldorfer alt beer, Pilsener beer, märzen beer, German weizenbier, Berliner weisse, Saisons beer, abbey beer, Trappist beer, gueuze, Iambic beer, fruit beer, Belgian white beer, high alcohol beer, low alcohol beer, non-alcoholic beer, low calorie beer, light beer, non-alcoholic malt beverages and the like.

Brewing as used here is used to indicate the production process of a beer, typically a brewing process comprises following steps (Goldammer 2000):
“Malting” involves the germination of cereal grains by steeping and soaking in water to allow sprouting. During sprouting several types of enzymes are produced, including those that catalyze the conversion of starch into simple, fermentable sugars. The germinated grains are then dried and roasted (a process called “kilning”) to kill the sprouts and to provide the grain with roasted grain flavors and color. Grains treated this way are called malted grains or simply “malt”.
“Milling” The malt is milled to crack the grains and to remove the sprouts, which allows the content of the malted grains to be better exposed to water during mashing and boiling. Milled malted or unmalted grains used for brewing are called “grist”.
“Mashing” involves the mixing of grist with water, called the “brewing liquor”, thus obtaining the so-called “mash”. The mash is heated to reach more optimal temperatures for the activity of malt enzymes or exogenously added enzymes. During mashing, oligosaccharides, disaccharides and monosaccharides are generated by enzymatic breakdown of complex carbohydrates, mainly starch, and amino acids are formed by proteolysis. Such simple sugars and amino acids form a carbon, nitrogen and energy source for the microorganisms during fermentation.
“Lautering” involves the separation, usually by filtering, of the mash into a liquid extract, called “wort”, and the insoluble materials, called “spent grains”. When the separation is completed, the spent grains bed on the filter is sparged with water, also called the “sparging liquor”, in order to recover wort that is entrapped by the spent grains.
“Wort boiling” involves heating of the wort at boiling temperature. The key purposes of boiling are i) to kill the microorganisms in order to eliminate competition for the fermentation microorganisms, ii) to coagulate proteins by thermal denaturation and to flocculate them, also called “hot break”, and iii) to extract and chemically modify bitter, aromatic and flavoring compounds from hops, hop extracts, herbs or herb extracts added before or during wort boiling.
“Wort clarification’ involves the removal of the hot break formed during wort boiling, i.e. insoluble material such as coagulated proteins, polyphenol-protein complexes and hops vegetative material from the boiled wort.
“Cooling and inoculation” involves the cooling of the clarified wort to a temperature that is optimal for the fermentation microorganisms. During cooling, proteins flocculate through association with polyphenolic compounds, called “cold break”. The fermentation microorganisms, for example brewer's yeast (Saccharomyces cerevisiae), are either added on purpose to the cooled wort (called “pitching”) or added by spontaneous inoculation.
“Fermentation” involves the incubation of the wort inoculated with the fermentation microorganisms. During fermentation the simple sugars are converted by these microorganisms into carbon dioxide (CO₂), ethanol and numerous by-products.
“Post-fermentation processing” involves the steps following primary fermentation up to the production and packaging of a finished beer. Depending on the type of beer and the method used, such post-fermentation processing may involve one or more of the following: the beer may be conditioned to further develop desirable flavors and aromas and/or reduce the levels of undesirable flavors and aromas; the beer can be filtered to remove the residual yeast and other turbidity-causing materials; the beer can be treated with an adsorbent to remove particular compounds such as hydrophilic proteins or polyphenols; the beer can be subjected to additional fermentation steps (with or without addition of an extra carbon source); herbs or herb extracts can be added; fruits or fruit extracts can be added; the beer can be carbonated to increase the bubbly aspect of beer; the beer can be pasteurized or microfiltrated to enhance microbial stability; and the beer can be packaged by e.g. bottling, canning or kegging.

The invention is further illustrated by way of the illustrative embodiments described below.

### Illustrative Embodiment

### EXAMPLES

### Example 1

### Preparation of Hop Polyphenol Extracts

Materials and Methods

Materials

Hop pellets cv Saaz, Hersbrucker Spät and Magnum, as well as the vegetative waste material of lupulin-enriched pellets T45 cv Hallertau Select, were obtained from Joh. Barth & Sohn (Nürnberg, Germany). Commercial spent hops cv Saaz and cv Magnum were obtained from Botanix ltd. (Paddock Wood, England). In-house spent hops were obtained by supercritical CO₂ extraction of hop pellets T90 cv Magnum and cv Hersbrucker Spät at 250 atm and 50° C., using a Dionex SFE703 extractor.

Evaluation of Polyphenolic Preparations

The reducing power of the polyphenolic preparations was assessed by spectrophotometric measurement of the discoloration of the 1,1-diphenyl-2-picrylhydrazyl (DPPH) radical at 525 nm according to Kaneda et al (1995). Alternatively, reducing power was determined by the ITT test, in which discoloration of 2,6-dichlorophenol indophenol by reduction by the beer components is measured after 1 minute incubation at ambient temperature. Total polyphenol content of the polyphenolic preparations was determined by EBC method 9.9.1 (Analytica EBC,1998).

High Performance Liquid Chromatography-Ultraviolet (HPLC-UV) analysis of hop polyphenols was performed on a Merck Hitachi Lachrom system (Merck, Darmstadt, Germany), consisting of a L-7100 programmable pump, a L-7450a DAD detector, a L-7350 column oven, a L-7250 programmable autosampler and a D-7000 interface. Solvents were degassed in line using a Recipe DG-4000 degasser (Recipe, Munich, Germany). Separations were carried out on an Alltima reversed phase octadecylsilica column (5 μm beads, Alltech associates, Deerfield, USA) of 250×4.6 mm at a temperature of 35° C. and a flow rate of 0.9 ml/min. The ultraviolet (UV) detector was set at 280 nm to detect flavanoids, cinnamic acid derivatives and specific prenylated flavonoids. A wavelength of 350 nm was used for the detection of flavonol glycosides and xanthohumol. The mobile phases were (A) formic acid/water (1/99) and (B) acetonitrile/methanol (5/95). Gradient conditions: linear gradient from 100% A to 100% B in 120 min; reverse gradient in 15 min; 100% A for 2 min.

Liquid Chromatography-Mass Spectrometry (LC-MS) of polyphenolic preparations was performed on a Waters (Milford, Mass., USA) 2690 system using a similar gradient profile as in HPLC-UV analysis described above. The HPLC was connected to a Micromass (Manchester, UK) QTOF II mass spectrometer via an electrospray ionisation (ESI) interface. A solution of poly-DL-alanine (Sigma, St. Louis, Mo., USA) in methanol was used to calibrate the mass spectrometer in the range 50-900 atomic mass units.

Results and Discussion

The objective was to develop a method for preparing a polyphenol-enriched hop extract that is more simple and more economically feasible than described methods, yet has a high yield of all major polyphenol classes from hops. Therefore several methods were devised and compared to a reference method. The reference method (hereafter referred to as method A) for extraction of hop polyphenols was the method no 5 published by Everaert (1992). This method is lengthy and involves three different solid-liquid extraction steps and two different liquid-liquid extraction steps. It is therefore suitable for research purposes but not for industrial scale extraction.

Hop polyphenol extraction method A: 5 g of hop pellets (T90 cv Hersbrucker Spät) was extracted according to method No 5 in Everaert (1992) and the final extract was made up to 50 ml with pure ethanol.

Hop polyphenol extraction method B: 15 g of hop pellets (T90 cv Hersbrucker Spät) were mixed with 150 ml of an ethanol-water (1/1 v/v) mixture and placed in an ultrasonic bath for 10 minutes. The mixture was kept for 30 min in the dark and placed for another 10 minutes in an ultrasonic bath. The vegetative particles were separated from the liquid fraction by centrifugation and filtration. After adjusting the pH to 4 with H₃PO₄ (1M), the liquid fraction was extracted 3 times with 100 ml n-hexane. The n-hexane phase obtained after liquid-liquid extraction was removed and the aqueous phase was retained. The aqueous phase was concentrated by evaporation under reduced pressure to a final volume of approx. 25 ml, and the extract was made up to 50 ml with pure ethanol.

Hop Polyphenol extraction method C: 5 g of hop pellets (T90 cv Hersbrucker Spät) were mixed with 80 ml ethanol/H₂O (3/1; v/v) and boiled for one hour under reflux in a nitrogen atmosphere. The liquid fraction was decanted over a filter and fresh extraction liquid was mixed with the hop material. This process was repeated three more times. The combined extract (320 ml) was reduced to approximately 20 ml using a rotary evaporator. The flask was rinsed two times with 10 ml pure ethanol and made up to 50 ml with ethanol/H₂O (1/1; v/v). The pH was adjusted to pH 4 with H₃PO₄ (1M) and the acidified solution was extracted 5 times with 50 ml n-hexane. The n-hexane phase obtained after liquid-liquid extraction was removed and the aqueous phase was retained. The aqueous phase was concentrated by evaporation under reduced pressure to a final volume of approx. 5 ml, and the extract was made up to 50 ml with ethanol/H₂O (1/1; v/v).

Hop polyphenol extraction method D: 5 g of hop pellets (T90 cv Hersbrucker Spät) were mixed with 80 ml ethanol/H₂O (9/1; v/v) and boiled for one hour under reflux in a nitrogen atmosphere. The liquid fraction was decanted over a filter and fresh extraction liquid was mixed with the hops material. This process was repeated once more. In total, the hops were boiled for three hours, resulting in 240 ml of liquid fraction. The pH was adjusted to pH 4 with H₃PO₄ (1M) and the acidified solution was extracted 5 times with an equal volume of n-hexane. The n-hexane phase obtained after liquid-liquid extraction was removed and the aqueous phase was retained. The aqueous phase was concentrated by evaporation under reduced pressure to a final volume of approx. 5 ml and the extract was made up to 10 ml with pure ethanol.

Hop polyphenol extraction method E: 5 g of hop pellets (T90 cv Hersbrucker Spät) were mixed with 80 ml ethanol/H₂O (9/1; v/v) and boiled for one hour under reflux in a nitrogen atmosphere. The liquid fraction was decanted over a filter and fresh extraction liquid was mixed with the hops material. This process was repeated once more. In total, the hops were boiled three hours, resulting in 240 ml of liquid fraction. The extract was reduced to small volume using a rotary evaporator and was made up to 50 ml with ethanol/H₂O (1/1 v/v). The pH was adjusted to pH 4 with H₃PO₄ (1M) and the acidified solution was extracted 5 times with 50 ml n-hexane. The n-hexane phase obtained after liquid-liquid extraction was removed and the aqueous phase was retained. The aqueous phase was concentrated by evaporation under reduced pressure to a final volume of 5 ml, and the extract was made up to 10 ml with pure ethanol.

Hop polyphenols sample A (obtained with method A), samples B1 and B2 (obtained with method B), samples C1 and C2 (obtained with method C), samples D1 and D2 (obtained with method D), samples E1 and E2 (obtained with method E) were analysed with respect to their total polyphenol content and reducing power measured by both the DPPH and ITT method (Table 1). Despite being much simpler and encompassing fewer steps than the reference method A, method C produces hop polyphenol extracts with a higher reducing power. In Table 2, the extraction yields of some marker polyphenols, as measured by quantitative HPLC-UV, are compared for the different samples. It was observed that the reference method A did not yield total polyphenolic extracts since the prenylated flavonoids (e.g. xanthohumol) were only present in low quantities. The extracts obtained using extraction method C contain significantly higher amounts of health beneficial prenylated flavonoids such as xanthohumol. Method C further shows a good reproducibility and yields selective total hop polyphenol extracts without significant modifications during the extraction process.

To select the most appropriate raw material for extraction of polyphenols from hops, several hop products were extracted following method C. High reducing power and economical production were used as main criteria for the selection of the most suitable starting material. The polyphenolic content and the reducing power, measured as DPPH-radical scavenging activity, of a variety of total hop polyphenol extracts are summarized in Table 3. The content of selected polyphenolic marker components in the extracts, as determined by quantitative HPLC-UV analysis, is shown in Table 4.

Table 3 shows that the reducing power of hop products depends mainly on the hop variety. Reducing power is clearly correlated with the polyphenolic content. The aroma hops (cv Saaz, cv Hersbrücker Spät, cv Hallertau Select) yield extracts that contain more polyphenols and have a higher reducing power compared to the bitter hops (cv Magnum). The polyphenolic profile is dependent on the hop cultivar (see Table 4). Bitter hops (cv Magnum) are rich in prenylated flavonoids (such as xanthohumol, found in the lupulin glands of the hop flower) but contain relatively low amounts of other hop polyphenols (mainly present in the vegetative matter of hops). Aroma hops such as Saaz or Hersbrucker Spät contain relatively more flavanoids (for instance (+)-catechin), flavonol glycosides (for instance rutin) and proanthocyanidins (for instance procyanidin B3) but less prenylated flavonoids (for instance xanthohumol).

The removal of hop acids and hop essential oils by supercritical CO₂ extraction did not result in losses of particular polyphenolic compounds or reducing power (see results on spent hops in Tables 3 and 4). This illustrates that CO₂ extraction under normal processing conditions does not result in extraction of hop polyphenols. On the contrary, the reducing power of extracts from spent hops (i.e. the residue of supercritical CO₂ extraction) expressed per mass unit raw material was always higher than the reducing power of extracts made from pellets of the corresponding cultivar. Therefore, spent hops are a preferred source for the preparation of total hop polyphenol extracts according to the present invention. Moreover, as spent hops are a waste stream of the production of hop resin extracts made by CO₂ or non-polar organic solvent extraction, the total hop polyphenol extracts can be made in an economical way on industrial scale starting from this material.

During the industrial production of lupulin-enriched pellets (better known as T45 pellets), part of the vegetative material is discarded as a waste product. An aqueous ethanolic extract from this vegetative residue is relatively rich in flavonol glycosides, flavanoids and proanthocyanidins, but contains relatively less prenylated flavonoids (see Table 4). Such extract also shows high reducing power (see Table 3). Therefore, the vegetative waste material of T45 pellet production is another preferred source for the preparation of hop polyphenol extracts according to the present invention. Although the obtained polyphenol extracts cannot be regarded as total hop polyphenol extracts, they still contain health beneficial polyphenols such as rutin.

Method F was developed as a pilot scale method for extraction of hop polyphenols. This method is similar to method C with two modifications to further increase economic feasibility: i) the vegetative residue obtained after supercritical CO₂ extraction was used instead of hop pellets; ii) the extraction with aqueous ethanol was performed at room temperature instead of boiling temperature.

Hop polyphenol extraction method F: 500 g of spent hops (i.e. the residue of hops previously extracted by supercritical CO₂ to obtain a hop alpha-acid extract) was suspended in 10 litre of an ethanol/water (3/1; v/v) solution. The suspension was stirred for 2 hr at room temperature under nitrogen atmosphere. The hop solids were removed by filtration and the filter was washed two times with 2.5 litre ethanol/water (3/1;v/v). The clear liquid was concentrated by evaporation under partial vacuum (nitrogen atmosphere, temperature was kept below 60° C.) until a final volume of 500 ml was reached. To this aqueous extract, 500 ml pure ethanol was added and the pH was adjusted to pH 4 with phosphoric acid (5%). The acidified extract was extracted 3 times with 1000 ml n-hexane after which the n-hexane was removed and the aqueous phase was concentrated to 900 ml by evaporation under reduced pressure. The solution was then made up to 1000 ml with pure ethanol.

In Table 5, the polyphenolic composition of a total hop polyphenol extract prepared by method F is compared with the composition of an extract obtained with method C. From the data in Table 5 it can be concluded that both methods yield extracts with a relatively similar polyphenol composition. The total polyphenol content of the extract is higher with method F (21.8% w/w) than with method C (14.4% w/w), and method F is therefore a preferred method for extraction of total polyphenols.

FIG. 1 shows the HPLC-UV chromatogram of the total hop polyphenol extract from cv Saaz obtained by method F. In the chromatogram no hop acids can be detected, thus demonstrating the high purity of the polyphenolic extract.

Hop polyphenol extraction methods A, B, C, D, E and F all include a liquid-liquid extraction step of the aqueous ethanol extract using the non-polar solvent n-hexane. Other non-polar solvents can be used, such as liquid or supercritical CO₂, chloroform, methylene chloride, toluene, benzene, petroleum ether or diethyl ether. The liquid-liquid extraction with the non-polar solvent serves to remove undesired residues of apolar compounds such as chlorophyll and lipids which are extracted by the aqueous ethanol. In order to omit the liquid-liquid solvent extraction step used in methods A, B, C, D, E and F, method G (see below) was developed. In method G, the polarity of the aqueous ethanol solvent was increased such that non-polar compounds become less extracted. To this end, the solvent used in method G was a mixture of ethanol and water in a 1 to 4 ratio.

Hop polyphenol extraction method G: 500 g of spent hops (i.e. the residue of hops previously extracted by supercritical CO₂ to obtain whole pure resin extract) was stirred for 2 hours with 10 litre of an ethanol/water mixture (20/80; v/v) at ambient temperature. The suspension was filtered over hydrophilic gauze to remove the hop solids and the residue was washed with 5 litre ethanol/water (20/80; v/v). The filtrate was concentrated to 1 litre by evaporation under reduced pressure and under nitrogen atmosphere. The concentrated extract was then filtered over a 1 μm cellulose sheet filter and the filter sheet was rinsed with 400 ml of an ethanol/water (20/80; v/v) mixture.

The extract made according to method G contains relatively more flavonol glycosides and relatively less prenylated flavonoids compared to method C (see Table 6). Method G is therefore a preferred method for preparation of an extract enriched in flavonol glycosides.

In the hop polyphenol extraction methods A, B, C, D, E, F, and G the ethanol used in the polar solvent can be replaced by other alcohols that are soluble in water such as methanol, propanol or butanol. However, for reasons of compatibility with food or beverage products the use of ethanol is preferred, as potential ethanol trace residues cause no problem in food and beverage products.

A method was also developed to obtain hop polyphenol extracts highly enriched in particular classes of polyphenols. The method is based on reversed phase chromatography on a polymeric matrix with hydrophobic side chains, such as for instance ethyl (C2), butyl (C4), octyl (C8) or octadecyl (C18) side chains. Method H (see below) was applied on total hop polyphenol extract C or F, and method I (see below) was applied on the flavonol glycoside enriched hop extract obtained by method G, but was otherwise principally the same as method H.

Hop proanthocyanidin, flavonol glycoside and prenylated flavonoid extraction method H: Total hop polyphenol extract prepared by methods C or F were further fractionated by reversed phase chromatography on octadecylsilica (C18 silica, Lichroprep RP-18, 24-40 μm, Merck, Darmstadt, Germany). Fractionation was performed on a solid phase column containing 25 g octadecylsilica. The column was conditioned consecutively with 80 ml ethyl acetate, 100 ml methanol and 200 ml milli-Q-water. Total polyphenolic extract (500 ml) was concentrated to 250 ml. To this concentrated extract, 40 ml of pure ethanol was added, and 100 ml of the mixture was applied on the column. The column was eluted with 200 ml milli-Q-water and 80 ml ethanol/water (5/95; v/v) and these combined fractions are called the “proanthocyanidin fraction”. The “flavonol glycoside fraction” was obtained by eluting with 100 ml ethanol/water (40/60; v/v). Finally, the “prenylated flavonoid fraction” was obtained by eluting with 100 ml pure ethanol. Alternatively, after loading of the total hop polyphenol extract, the column can first be washed with ethanol/water (5/95; v/v) and subsequently eluted with pure ethanol to obtain a fraction containing both flavonol glycosides and prenylated flavonoids.

Flavonol glycoside extraction method I: Further purification of the flavonol glycoside enriched hop extract obtained by method G was performed on a solid phase column containing 25 g octadecylsilica (C18 silica, Lichroprep RP-18, 2440 μm, Merck, Darmstadt, Germany). The column was conditioned consecutively with 80 ml ethyl acetate, 100 ml methanol and 200 ml milli-Q-water. The flavonol glycoside enriched hop extract (50 ml) was diluted with 50 ml milli-Q-water and applied on the column. The column was washed with 200 ml milli-Q-water and another 100 ml of the flavonol glycoside enriched hop extract (diluted 1:1 with milli-Q water) was applied on the column. This was repeated once more, after which the column was rinsed with 80 ml ethanol/water (5/95; v/v). The “flavonol glycoside fraction” was obtained by eluting the column with 100 ml ethanol/water (40/60; v/v).

HPLC-UV analysis of the proanthocyanidin, flavonol glycoside, and prenylated flavonoid fractions isolated from cv Hersbrucker Spät by method H demonstrates the selectivity and efficiency of the extraction/fractionation procedure (FIG. 2). FIG. 3 shows the base peak intensity traces of the different polyphenolic hop preparations, acquired by LC-MS in ESI-mode. In the total polyphenolic extract prepared by method G we could identify two procyanidins, catechin, epicatechin, rutin, quercetin-galactoside, isoxanthohumol, 8-prenylnaringenin, desmethylxanthohumol, 6-prenyinaringenin and xanthohumol. In the hop flavonol glycoside fraction prepared by method H we could identify the flavanols catechin and epicatechin and the flavonol glycosides rutin (quercetin-rhamnosyl-glucoside), quercetin galactoside, and kaempferol glucoside. In the hop prenylated flavonoid fraction prepared by method H we could identify the prenylated flavonoids xanthohumol, isoxanthohumol, desmethylxanthohumol, 6-prenylnaringenin, 8-prenylnaringenin, 6-geranylnaringenin, and 8-geranylnaringenin.

The distribution of the reducing power and polyphenolic content over the different polyphenolic fractions prepared by method H (cv Hersbrucker Spät) are shown in Table 7. The majority of hop polyphenols present in the total hop polyphenol extract from cv Hersbrucker Spät are of proanthocyanidin nature and the prenylated flavonoids are the least abundant. The distribution of the radical scavenging activity is clearly correlated with the polyphenolic content of the respective fractions. The distribution of selected polyphenolic marker components over the three fractions, proanthocyanidins, flavonol glycosides, and prenylated glycosides, is shown in Table 8. From the distribution of the selected marker components it can be concluded that an excellent separation of the key polyphenol classes over the three fractions is achieved.

The concentrations of the selected polyphenolic marker components of the flavonol glycoside fraction prepared by method H and the flavonol glycoside fraction prepared by method I are shown in Table 9. Both methods yield extracts that are highly enriched in polyphenols: 52% (w/w) for method H and 50% (w/w) for method 1. From the composition of the selected marker components, it can be concluded that both methods result in highly enriched flavonol glycoside fractions: the sum of the 4 different flavonol glycoside marker polyphenols (rutin, quercitin derivative, kaempherol-3-glucoside and kaempherol derivative) is 42% (w/w) for the flavonol glycoside fraction of method H and 40% (w/w) for that of method 1. Rutin is with 14% (w/w) the most abundant polyphenol in flavonol glycoside fractions prepared by both methods H and I. The fractionation method I is based on extraction method G, which is more simple and more economical than extraction methods C or F that are at the basis of fractionation method H. Hence, method I is preferred for the production of a highly enriched flavonol glycoside extract.

### Example 2

### Sensory Evaluation of Hop Polyphenol Extracts

Materials and Methods

Extraction of Different Hop Essential Oil Fractions

Preparation of Total Essential Hop Oil

Prior to extraction, hop pellets T90 cv Saaz were disrupted using a pestle and mortar to facilitate the extraction. The vegetative matter was then immediately extracted using a Dionex SFE-703 supercritical fluid extractor (Dionex, Sunnyvale, 94086 Calif., USA). Carbon dioxide was obtained from Air Liquide (SFE/SFC grade; Air Liquide Benelux, Liège, Belgium) The SFE equipment consists of three main parts: a thermostatic sample oven containing up to eight extraction cells, a flow restrictor at the end of each extraction line, and a cooled cryo rack (approx. 5° C.) holding the collection vials. The collection vials are screw-capped glass containers wherein a central inner glass tube is suspended to the closing septum. Trapping of the extracted material is essentially based on cold solvent trapping, although instant condensation and enrichment of less volatile hop oil constituents invariably occurs at the cold surface of the inner glass tube. Ethanol (LC-grade, Merck, Darmstadt, Germany) was used as trapping solvent to ensure compatibility with the beer matrix. Stainless steel extraction cells (10 ml) were filled with ground hop material (approx. 5 g) and placed in the sample oven at 50° C. The restrictors (flow size: 500 ml) were set at 175° C. to prevent plugging. The SFE extraction was then carried out at a pressure of 110 atm and a temperature of 50° C. until a volume of 25 litre of gaseous CO₂ was registered by the flow meter. After extraction, the collection vial was shaken to dissolve the hop oil constituents on the inner glass tube.

Preparation of the Polar Fraction of Total Hop Oil (Also Referred to as Dry Hop Essence)

Varietal total essential hop oil was prepared by SFE as described above. Removal of hydrocarbons (monoterpenes and sesquiterpenes) from essential hop oil was achieved via solid phase extraction (SPE). Varian Bond Elut C18 cartridges (500 mg) (Varian, Palo Alto, Calif., USA) were employed for this purpose. The SPE columns were pre-conditioned with 10 ml HPLC-grade ethanol, followed by 10 ml ethanol/water (1/1; v/v) (both HPLC-grade). Next, total essential hop oil extract, obtained by previous SFE, was adsorbed on the column and separated into six fractions (3 ml each) by gradually raising the ethanol concentration from 50% to 100%. The fraction eluting with 70% ethanol contained the spectrum of oxygenated hop oil constituents. This fraction is the polar fraction of total essential hop oil, also referred to as “dry hop essence”.

Preparation of Citrus, Floral, and Spicy Hop Essences

The SFE extraction was carried out in two sequential stages (cf. principle of fractionated extraction). This procedure allows very efficient separation of different sensory aspects of hop oil, in contrast to the commercial protocol for the preparation of hop essences. The first SFE extraction was performed at a CO₂ pressure of 90 atm and a temperature of 50° C. until a volume of 25.0 litre of gaseous CO₂ was measured by the flow meter. During this step, the most volatile hop oil constituents with citrus and floral aromas are selectively extracted and trapped in the cold solvent (ethanol). After changing the collection vial, the remaining hop solids were extracted at 110 atm and 50° C. until a volume of 25.0 litre of gaseous CO₂ was collected. During this second SFE step, the less volatile oxygenated sesquiterpenes are selectively extracted and, together with part of the sesquiterpene hydrocarbons, immediately condensed at the surface of the central glass tube. After the second extraction, the inner tube was carefully loosened from the septum and the enriched sesquiterpenoid hop oil fraction was dissolved in ethanol (3 ml).

On the extract of the first 90 atm pressure step, further fractionation was carried out by solid phase extraction (SPE) as described above. Three highly enriched hop oil fractions were obtained in this manner, namely:
“citrus hop essence 1”: fraction eluting with 50% ethanol;
“citrus hop essence 2”: fraction eluting with 60% ethanol;
“floral hop essence” : fraction eluting with 70% ethanol.

On the sesquiterpenoid preparation obtained via the second 110 atm pressure extraction, further purification was carried out by solid phase extraction (SPE) as described above. The fraction eluting with 70% ethanol contained the full spectrum of purified oxygenated hop sesquiterpenes (Goiris, 2002). This hop oil fraction is further indicated as “spicy hop essence”.

Preparation of Experimental Beers

For sensory evaluation of hop polyphenol extracts in top fermented beers and pilsner beers, several brews were prepared in a pilot scale brewery (4 hl).

Brewing of the pilsner type (bottom fermented) beers was done as follows: grist: pilsner malt (80 kg), coarse milling (two-roller mill); brewing water: reverse osmosis (2.8 hl) with addition of Ca²⁺ (40 mg/l); brewing scheme: 45° C. (15 min), 52° C. (20 min), 63° C. (30 min), 72° C. (20 min), 78° C. (120 min, including wort filtration with lauter tun); pH of the mash controlled at pH 5.5 by ISFET electrode and addition of lactic acid; wort boiling: 60 min (evaporation: about 8%); wort clarification: whirlpool; addition of Zn^{2+l (}0.2 mg/l) to clarified wort; original wort gravity: 12° P; pitching rate: 10⁷ cells/ml; fermentation: 9 days at 10° C.; hopping: addition of isomerised hop acid extract (20% iso-α-acids w/v, Botanix ltd., Paddock Wood, England) at end of wort boiling; maturation: in cask (10 days at 2° C.); beer filtration: kieselguhr/cellulose sheets (1 μm). All beers were bottled and sealed in brown standard 25 cl bottles (O₂-content <80 ppb) using an isobaric filling machine with double pre-evacuation (America monobloc, Cimec, Italy).

Brewing of the top fermented beers was done as follows: grist: pilsner malt (55 kg), coarse milling (two-roller mill); brewing water: reverse osmosis (1.65 hl) with addition of Ca²⁺ (40 mg/l); brewing scheme: 52° C. (20 min), 63° C. (40 min), 72° C. (20 min), 78° C. (120 min, including wort filtration with lauter tun); pH of the mash controlled at pH 5.3 by ISFET electrode and addition of lactic acid; wort boiling: 75 min (evaporation: about 8%); wort clarification: whirlpool; addition of Zn²⁺ (0.2 mg/l) to clarified wort; original wort gravity: 16° P; pitching rate: 5.10⁶ cells/ml; fermentation: 7-9 days at 22-25° C.; hopping: addition of isomerised hop acid extract (20% iso-α-acids w/v, Botanix ltd., Paddock Wood, England) at end of wort boiling; maturation: in cask (10 days at 2° C.); beer filtration: kieselguhr/cellulose sheets (1 μm). All beers were bottled and sealed in brown standard 25 cl bottles (O₂-content <80 ppb) using an isobaric filling machine with double pre-evacuation (America monobloc, Cimec, Italy).

Additions of hop polyphenol extracts were made either at maturation or to the finished beers. Additions of hop aromas were made to the finished beers. Addition of hop pellets (T45 cv Saaz; 4.58% (w/w) hop alpha-acids; Joh. Barth & Sohn, Nürnberg, Germany) to one of the brews was done at onset of wort boiling.

Sensory Analyses.

Sensory analyses were conducted in a quiet room. The sensory properties of the polyphenol preparations in fresh beer were evaluated by a trained panel. The sensory properties hoppy smell intensity, hop aroma intensity, bitterness intensity, fullness, astringency and stickiness were given a score from 1 (very weak) to 5 (very strong) according to Kaltner et al (2001). The sensory properties hoppy smell quality and hop aroma quality were given a score from 1 (very unpleasant) to 5 (very pleasant). The ranking scores were analysed statistically by Friedman's rank sum test according to EBC method 10.11 (EBC analytica).

Results and Discussion

The sensory effects of total hop polyphenol extracts on the sensory properties of beer were investigated. In a first preliminary tasting session, total hop polyphenol extracts prepared by method C (see example 1) from cv Magnum and cv Hersbrucker Spät were added at 20 mg polyphenol per litre to a top fermented beer at the end of maturation. All panelists could distinguish the beers with addition of hop polyphenols in a triangular test, and all noted a higher fullness of the beers with addition of hop polyphenols compared to the reference beer without added hop polyphenols. Further, the panelists described the differences between the polyphenol extracts derived from both varieties. The beer with total hop polyphenol extract from the aroma hop cv Hersbrucker Spät was more drying and had more fullness than the beer with polyphenols extracted from the bitter hop cv Magnum.

In another preliminary blind tasting session, a bottom-fermented pilsner beer bittered with isomerised hop acid extract with addition of total hop polyphenol extract (prepared from cv Saaz by method F, see example 1) during maturation was compared to a pilsner beer exclusively hopped with isomerised hop acid extract without addition of hop polyphenols. Five out of six trained panelists preferred the beer with added total hop polyphenol extract, and the panelists noted that the beer with added hop polyphenol extract had an increased fullness.

The effects of the addition of total hop polyphenol extract on the sensory properties bitterness, fullness, astringency, and stickiness were analyzed with a sensory panel of 17 trained individuals (Table 10). To this end total hop polyphenol extracts prepared from different hop cultivars by method C (see example 1) were added at a concentration of 10 mg polyphenols per litre to a finished pilsner beer that was exclusively bittered with isomerised hop acid extract. Once again it was observed that, depending on the varietal origin, total hop polyphenol extracts impart varying sensory impressions to beer. In particular, effects on mouthfeel are subject to varietal differences. The highest impact on mouthfeel was obtained with addition of a total hop polyphenol extract from cv Hersbrücker Spät. The bitterness quality of the beer containing the total hop polyphenol extract from cv Saaz T90 pellets was described as fine, harmonic and was clearly preferred. No distinction in any of the sensory parameters could be made by the tasting panel between the beer with addition of total hop polyphenol extract from pellets of cv Magnum and the beer with addition of total hop polyphenol extract from spent hops of cv Magnum. Thus, from the sensory point of view, total hop polyphenol extracts prepared from spent hops pre-extracted by supercritical CO₂ have the same effect as extracts prepared from pellets.

In order to analyze the sensory effect of different types of polyphenols, the three different hop polyphenol fractions (proanthocyanidin extract, flavonol glycoside extract and prenylated flavonoid extract) prepared by method H (see example 1) were added to a finished pilsner beer at an amount of the fractions equivalent to 10 mg total polyphenol extract per litre. From the results shown in Table 11, it is clear that prenylated flavonoid extract and particularly flavonol glycoside extract contribute positively to the fullness of the beer. On the other hand, addition of proanthocyanidin extract raised astringency to a level that was experienced as unpleasant. Beers with added flavonol glycoside extract were preferred by the panelists and showed the highest increase in fullness. Addition of such hop flavonol glycoside fractions further results in an increase in the levels of health beneficial hop polyphenols (Piendl and Biendl, 2000; Raj Narayana et al, 2001; Gerhauser et al 2002; Piendl, 2002; Kanadaswani, 2005) such as rutin in the beer.

The positive sensory properties of the flavonol glycosides and prenylated flavonoids are unexpected given that hop polyphenols have been disregarded as flavorants in the prior art (US 2003/0138546). In fact our data are not in contradiction with previous reports, as we have not noted effects on the basic taste of beer per se, yet we have found that the effect of the hop polyphenolic compounds are primarily focused on mouthfeel. The hop polyphenols are therefore probably more potentiators of mouthfeel which is an important aspect of overall flavor. Our findings also indicate that not all polyphenolic compounds have the same sensory effect. Hop proanthocyanidins caused unwanted astringency but not fullness and flavonol glycosides provide the highest fullness and most harmonious flavor.

To further illustrate the sensory properties of the polyphenolic hop preparations, total hop polyphenol extract and flavonol glycoside extract were added to a top fermented beer and the resulting beers were evaluated using a scoring system by a sensory panel of 15 trained panelists. Score differences between two beers by more than 0.5 units are considered significant and reliable. The data in Table 12 show that the addition of total hop polyphenol extract prepared by method F (see example 1) at 20 mg polyphenols per litre to top fermented beer during maturation increases the fullness and bitterness intensity of the beer. Exhaustive descriptive sensory analysis of top fermented beer without or with addition of total hop polyphenol extract (10 mg/l) indicated that, besides the increase in fullness and bitterness intensity, the total hop polyphenol extract imparted no other sensory alterations except for a slight decrease in the perception of fruity aromas. The addition of 2 mg per litre flavonol glycoside extract prepared by method I (see example 1) during beer maturation resulted clearly in an increased fullness of the top fermented beer (see Table 13). The astringency and stickiness of the beer was not significantly altered by the use of flavonol glycosides. Exhaustive descriptive sensory analysis of top fermented beer with or without addition of flavonol glycoside extract indicated that, besides the increase in fullness of the beer, the flavonol glycoside extract imparted no other sensory alterations except for a slight decrease in the perception of fruity aromas.

The total hop polyphenol extract prepared by method F (see example 1) and the hop flavonol glycoside extract prepared by method I (see example 1) were also tested in pilsner beers in combination with isomerised hop acid extract added at the end of boiling and hop essences (dry hop essence, spicy hop essence, floral hop essence) added after wort boiling. Such beers can be considered as fully advanced hopped beers, as all hop fractions with brewing value were extracted prior to addition at specific times of the brewing process. For sensory evaluation, the beers with addition of hop aromas were served together with the corresponding beer without hop essences, without disclosing the identity of the samples. The data on sensory evaluation of the pilsner beers with addition of hop polyphenols and hop aromas are summarized in the Tables 14 and 15. The results from the sensory evaluation clearly show that the fullness of the pilsner beer was always significantly increased both with addition of total hop polyphenol extract and flavonol glycoside extract. Addition of the hop essences also increased fullness compared to the reference beer, but the combinations of hop essences with total hop polyphenol extract or flavonol glycoside further significantly increased fullness. Highest fullness scores were noted for the combination of flavonol glycoside extract and floral hop essence and the combination of flavonol glycoside extract and dry hop essence. Astringency levels and bitterness intensity also increased with addition of hop polyphenols. However, the level of astringency in all beers was given a weak to moderate score and did not impair the beers with added hop polyphenols from being selected as preferred beer. The hop essences caused a significant increase in hop smell intensity and hop aroma intensity, but the hop polyphenols did not cause a further significant increase in these scores. Beers with addition of hop polyphenols and hop aromas were preferred by the sensory panel over the reference beer without addition of polyphenols or aromas. The combination of dry hop essence and flavonol glycoside extract was preferred by the sensory panel in the flavonol glycoside beer series. The combination of floral hop essence and total hop polyphenol extract was preferred in the beer series with total hop polyphenol extract.

In another tasting session with top fermented beers, the addition of total hop polyphenol extract in combination with isomerised hop acid extract and different hop essences (dry hop essence, spicy hop essence, floral hop essence) was compared to a beer made with the same ingredients but that was conventionally hopped with pellets. Total hop polyphenol extract prepared by method F (see example 1) was added during maturation, isomerised hop alpha-acids were added at the end of wort boiling, and hop aromatic oil was added to the finished beer. FIG. 4 gives an overview of the rank sums that were given by a sensory panel of 18 trained panelists. The beer with addition of total hop polyphenol extract in combination with isomerised hop alpha-acids and dry hop essence was the most preferred beer (p<0.01). The beer without hop aromatic oil was the least preferred beer in this tasting session. This points to the important role of hop aromas to complete the beer flavor. The fact that a fully advanced hopped beer, made with a combination of hop polyphenol extract, isomerised hop alpha acid extract and hop aromatic oil, is preferred over a conventionally hopped beer underscores the potential of the novel hopping technology disclosed in this invention.

### EXAMPLE 3

### Addition of Hop Polyphenol Extract During Mashing and Wort Boiling

Materials and Methods

Preparation of Experimental Beers

Four brews were prepared in a pilot scale brewery (4 hl) following the same process for sweet wort production. Brewing was done as follows: grist: pilsner malt (80 kg), coarse milling (two-roller mill); brewing water: reverse osmosis (2.8 hl) with addition of Ca²⁺ (40 mg/l); brewing scheme: 45° C. (15 min), 52° C. (20 min), 63° C. (30 min), 72° C. (20 min), 78° C. (120 min, including wort filtration with lauter tun); pH of the mash controlled at pH 5.5 by ISFET electrode and addition of lactic acid; wort boiling: 60 min (evaporation: about 8%); wort clarification: whirlpool; addition of Zn²⁺ (0.2 mg/l) to clarified wort; original wort gravity: 12° P; pitching rate: 10⁷ cells/ml; fermentation: 9 days at 10° C.; hopping: brews A and B, addition of isomerised hop acid extract (20% iso-α-acids w/v, Botanix ltd., Paddock Wood, England), at end of wort boiling; non-isomerised hop CO₂ extract cv Saaz (22% w/w, Joh. Barth & Sohn, Nurnberg, Germany) was added to brews C and D at onset of wort boiling; lagering: in cask (10 days at 2° C.); beer filtration: kieselguhr/cellulose sheets (1 μm). All beers were bottled and sealed in brown standard 25 cl bottles (O₂-content<80 ppb) using an isobaric filling machine with double pre-evacuation (America monobloc, Cimec, Italy). Total hop polyphenol extract, prepared from spent hops of cv Saaz by method F (see Example 1), was added at 50 mg polyphenols per litre at different stages in the brewing process (see below). Diversification of the brews was done as follows:
Beer A1: addition of isomerised hop acid extract at end of wort boiling
Beer A2: derived from same initial brew A as beer A1; addition of isomerised hop acid extract at end of wort boiling; addition of total hop polyphenol extract at onset of wort boiling
Beer B1: addition of total hop polyphenol extract to brewing liquor and sparging liquor; addition of isomerised hop acid extract at end of wort boiling
Beer B2: derived from same initial brew B as beer B1; addition of total hop polyphenol extract to brewing liquor and sparging liquor; addition of isomerised hop acid extract at end of wort boiling; addition of total hop polyphenol extract at onset of wort boiling
Beer C1: addition of non-isomerised hop CO₂ extract at onset of wort boiling
Beer C2: derived from same initial brew C as beer C1; addition of non-isomerised hop CO₂ extract at onset of wort boiling; addition of total hop polyphenol extract at onset of wort boiling
Beer D1: addition of total hop polyphenol extract to brewing liquor and sparging liquor; addition of non-isomerised hop CO₂ extract at onset of wort boiling
Beer D2: derived from same initial brew D as beer D1; addition of total hop polyphenol extract to brewing liquor and sparging liquor; addition of non-isomerised hop CO₂ extract at onset of wort boiling; addition of total hop polyphenol extract at onset of wort boiling

Standard Parameters of Beer

Alcohol content in beer samples was measured by near infrared spectroscopy (Alcolyzer Plus, Anton Paar), density was measured by an oscillating U-tube density meter (Alcolyzer Plus, Anton Paar), and apparent and real extract, apparent and real degree of fermentation and original gravity (original extract) were calculated from the alcohol and density measurements. Free amino nitrogen (FAN), pH, colour, total polyphenols, flavanoids, soluble protein, sensitive protein, and vicinal diketones were measured according to standard European Brewery Convention procedures and IOB-methods (Analytica EBC, 1998; IOB methods of analysis, 1997). Foam stability was measured using a Haffmans Nibem-T Foam stability tester (Drawert 1980). Dissolved oxygen content was measured using a Mettler Toledo InTap4000 portable DO analyzer in combination with a Haffmans Inpack sampler. Soluble protein was measured using the Bio-Rad® Protein Assay (Bio-Rad, Richmond, Calif., USA) which is based on the shift in the λₘₐₓ of coomassie brilliant blue when the dye binds to proteins.

Reducing power of the beers (DPPH radical scavenging activity) was measured as described in the Materials and Methods in Example 1.

Sensory Evaluation of Flavor Stability

Flavor stability of the eight pilot pilsners was assessed by a trained panel. The panelists were served the fresh and the aged beer (5 days at 40° C.) simultaneously, without disclosing the identity of the samples. In a first session, four pairs of beers, i.e. fresh and aged samples of beers A1, A2, B1 and B2, respectively were evaluated by 6 panelists. The fresh and aged samples of beers C1, C2, D1 and D2 were evaluated in a second session by 7 panelists. Panelists were asked to identify the aged sample, give ageing scores (procedure of Araki et al. (1999), 0: fresh; 1: very weakly aged; 2: weakly aged; 3: moderately aged; 4: strongly aged; 5: very strongly aged, undrinkable), and rank the aged samples of each session according to their degree of ageing (1: most fresh; 4 most aged). The ranking scores were analysed statistically by Friedman's rank sum test according to EBC method 10.11 (EBC analytica)

Colloidal Stability

The colloidal stability was measured using a Haffmans VOS-ROTA turbidity meter. Initial cold haze was measured after incubating the sample for 24 h at 0° C. After this, the sample was placed in a thermostatically controlled room at 40° C. for 24 h, subsequently cooled for 24 h at 0° C. and the cold haze was measured. After five cycles of 24 h warm phase and 24 h cold phase, the samples were kept at 20° C. for 24 h and the permanent haze was measured.

Nitrate Levels

Nitrate levels in the experimental beers were determined by capillary electrophoresis with a Waters Ion Analyzer using the following settings: hydrostatic injection; constant voltage at 15 kV; electrolyte: mixture of sodiumsulfate, OFM-OH (Waters) and disodiumtetraborate; capillary 60 cm×75 μm×320 μm; detection: UV absorbance at 214 nm.

Hydroxy Fatty Acids

Extraction of hydroxy fatty acids in pitching wort was performed by liquid-liquid extraction with diethylether. The organic phase was dried under a stream of nitrogen and freeze dried. To the dry sample a solution of n-C₂₁ was added as internal standard and the sample was dried again under nitrogen.

Prior to gas chromatography (GC) analysis, the samples were incubated with pyridine and silyl 991 reagent for 1 hour at 94° C. for derivatisation of hydroxy fatty acids.

The derivatized hydroxy fatty acids were quantified by GC analysis (ThermoFinnigan Trace GC) using the following settings: Carrier gas: Helium; Gas Flow: constant flow 1 ml/min; Column: 50 m WCOT Silica, CP-sil 5 CB low bleed MS, 0.25 μm film thickness; Oven conditions: 40° C. isothermal 5 min; 6° C./min to 290° C.; isothermal 3 min 290° C.; post run 20 min isothermal at 290° C. 15° C./min to 250° C. and 2 min isothermal at 250° C.; Injection: 1 μl on column; Detection: FID detection.

Extraction of Bitter Acids from Beer and HPLC Analysis of Iso-Alpha-Acids

The bitter iso-alpha-acids were extracted from the beers and subsequently analysed by high-performance liquid chromatography (HPLC) as described by De Cooman et al. (2000).

Results and Discussion

Eight different beers were brewed. Beers A1, A2, B1, B2 were bittered exclusively with a isomerised hop acid extract, while beers C1, C2, D1, D2 were bittered exclusively with a non-isomerised hop CO₂ extract. In this way, the impact of the addition of total hop polyphenol extract during brewing on the flavor stability was studied in both advanced hopped beers and conventionally hopped beers. For beers B1, B2, D1, D2 total hop polyphenol extract from spent hops cv Saaz prepared by method F (see example 1) was added during the mashing and lautering step by addition of 50 mg polyphenols per liter water in both the brewing liquor and sparging liquor. For beers A2, B2, C2, D2 total hop polyphenol extract from spent hops was added at 50 mg/l at the onset of wort boiling. Beers A1 and C1 were the reference brews without addition of total hop polyphenol extract.

The addition of total hop polyphenol extract is reflected by increased levels of total polyphenols in the brews A2, B1, B2, C2, D1, D2 as compared to the reference brews A1 and C1 (Table 16). The level of flavonol glycosides, represented by rutin, is particularly increased in the brews with added hop polyphenol extract (Table 17). The level of prenylated flavonoids, represented by xanthohumol, isoxanthohumol, 8-prenylnaringenin, 6-prenyl-naringenin, is elevated as well yet reach a lower level as rutin (Table 17). Nearly all added rutin is recovered in the beers, while only a fraction of added xanthohumol is recovered as either xanthohumol or its isomerised form isoxanthohumol, indicating that prenylated flavonoids precipitate more or adhere more than flavonol glycosides during the brewing process. The increase in flavanoids (represented by (+)-catechin, (−)-epicatechin), and proanthocyanidins (represented by prodelphinidin trimer, prodelphinidin B3, procyanidin trimer, procyanidin B3) is less outspoken, which is not surprising given that these polyphenols are also present in barley malt (Table 17).

The standard beer parameters (Table 16) were within the ranges of normal brew to brew variations for all brews, indicating that addition of hop polyphenols had no impact on these parameters. No negative effects on color and foam stability, and a normal attenuation were observed. Addition of hop polyphenols did not impair starch or protein breakdown, nor yeast performance, as normal fermentation profiles were observed (data not shown).

Surprisingly, the pitching wort of the brews C2, D1 and especially D2 contained significantly less hydroxy fatty acids than the reference brew C1 (see Table 18), indicating that less undesired oxidative transformations occurred during the brewing process in presence of hop polyphenols.

Previous methods to increase hop polyphenol content in beer resulted in an undesired increase in nitrate content of the beers as compared to beers made with conventional hop pellets (Forster et al. 1995). We therefore measured the nitrate content of the studied experimental beers and compared them with other pilot scale brews made in the same brewhouse (Table 19). Although the nitrate content slightly increased with the use of total hop polyphenol extract relative to addition of only isomerised hop acid extract or non-isomerised hop CO₂ extract, the nitrate levels of the beers with addition of hop polyphenol extract were significantly lower than in beers prepared by conventional hopping with pellets (see Table 19).

Addition of hop polyphenols to the brewing and sparging liquor resulted in a decrease in filtration time of the brews of approximately 15% (see FIG. 5). During the preparation of brew B1/B2, lautering was finished after 103 minutes, whereas in brew A1/A2, filtration took 120 minutes (FIG. 5A). Similar conclusions can be drawn when comparing brews C1/C2 and D1/D2 (FIG. 5B). Positive effects of other polyphenols such as gallotannins on wort filterability were described earlier by Aerts et al. (2001). Addition of hop polyphenols to the brewing and sparging liquor most probably inhibits the oxidation of gel-forming proteins and facilitates coagulation and flocculation of proteins, thus resulting in accelerated wort filtration.

The fresh beers were evaluated by the sensory panel in two separate blind tasting sessions. In the first session, the beers bittered with isomerised hop extract were compared. The results in FIG. 6 show that the beer Al without addition of hop polyphenols was the least preferred beer (p<0.1) in this session. From the beers made with non-isomerised hop extract, the beer C1 without addition of hop polyphenols was also the least preferred (p<0.001). The beer D1 with addition of 50 mg/l hop polyphenols to the brewing and sparging liquor was the most preferred (p<0.001) of the beers made with non-isomerised hop extract (see FIG. 7). Hence, the addition of hop polyphenols during the brewing process has a positive effect on the flavor of the fresh beers, especially when added during mashing and lautering.

Sensory evaluation of forced aged beers indicated a beneficial effect of the addition of hop polyphenols on flavor stability (FIGS. 8 and 9). The reference beers, without addition of hop polyphenols, whether prepared with isomerised hop extract (beer A1) or non-isomerised hop extract (beer C1), were the most susceptible to development of aged flavor. Addition of hop polyphenols to brewing and sparging liquor (beers B1 and D1, respectively) was clearly and significantly beneficial to overall flavor stability. On the other hand, addition of hop polyphenols at the onset of wort boiling (beers A2 and C2, respectively) did not result in a significant reduction of flavor deterioration. In general, beers prepared with isomerised hop extract (beers A1, A2, B1, B2) had a lower ageing score than the corresponding beers made with non-isomerised hop extract (beers C1, C2, D1, D2). The beer with the lowest ageing score, and hence the best flavor stability, was beer B1 which was prepared by addition of total hop polyphenol extract to the brewing and sparging liquor and addition of isomerised hop extract at the end of wort boiling (FIGS. 8, 9). Not only are the beers with addition preferred in their fresh state, but the sensory panel also noticed a significant improvement in the flavor stability.

The degradation of iso-alpha-acids as a function of beer ageing (FIG. 10) fits well with the sensory data. Bitter acids decay was less pronounced in the beers prepared with isomerised hop acid extract compared to the beers obtained with non-isomerised hop CO₂-extract. Addition of total hop polyphenol extract to brewing and sparging liquor resulted in prolonged stability of the iso-alpha-acids, as beer B1 showed the lowest level of bitter acids decay of the A and B brews and beer D1 showed the lowest level of bitter acids decay of the C and D brews.

Although the formation of cold haze increased (data not shown) when total hop polyphenol extract was used, the formation of permanent haze was reduced in all the beers with addition of hop polyphenols during brewing wether prepared with isomerised hop extract or with non-isomerised hop extract (FIG. 11). The increase in cold haze was expected, as polyphenols are known to interact reversibly with proteins to form temperature-dependent precipitates. However, such cold haze formation can be avoided for instance by passage of fermented beer over a silica gel filter to remove haze-sensitive hydrophilic proteins, a standard procedure that was not applied to the experimental brews A1, A2, B1, B2, C1, C2, D1 or D2. In contrast, the reduction in the formation of permanent haze in beers made with added hop polyphenols is unexpected. It suggests that hop polyphenols slow down the oxidative transformations that take place upon beer storage.

Different hop essences (spicy hop essence, floral hop essence, dry hop essence) were added to the finished pilsner beer B1 and these beers were compared with beer B1 and with reference beer A1 lacking hop polyphenol extract. The sensory properties, bitterness intensity, fullness, astringency and stickiness were assessed by a panel of 20 persons. Once more it became clear that addition of hop polyphenols and hop aromas improves the fullness and bitterness of beer (see Table 20). From the mean ranking for preference (see Table 21) it is concluded that the post fermentation addition of dry hop essence is clearly preferred by the sensory panel, despite the fact that this beer also has the highest astringency. This indicates that the taste of beers made with total hop polyphenols added at mashing in and isomerised hop acid extract added at the end of wort boiling can be further improved by the addition of hop aromas post-fermentation.

### REFERENCES

Aerts G., De Cooman L., De Rouck G., De Buck A., Van Waesberghe J. (2001) Proceedings of the 28th EBC Congress. Budapest, Hungary, Fachverlag Hans Carl, Nürnberg, Germany, 547-556.

Aerts G., De Cooman L., De Pril I., De Rouck G., Jaskula B., De Buck A., Van Hijfte B., De Pauw C., van Waesberghe J. (2003) Proceedings of the 29th EBC Congress, Dublin, Ireland. Contribution 34, 13 pp.

Analytica EBC (1998) Fachverlag Hans Carl, Nürnberg, Germany, 5^{th} edition.

Andersen M. L., Skibsted, L. H. (2001) Modification of the levels of polyphenols in wort and beer by addition of hexamethylenetetramine or sulfite during mashing. J. Agric. Food Chem., 49: 5232-5237.

Andersen M. L., Outtrup H., Skibsted L. H. (2000) Journal of Agricultural and Food Chemistry 48: 3106-3111.

Araki S., Kimura T., Shimizu C., Furusho S., Takashio M., Shinotsuka K.(1999) Journal of the American Society of Brewing Chemists, 57: 34-37.

Bamforth C. W. (2000) Beer: an ancient yet modern biotechnology. The Chemical Educator. 5: 102-112.

Bushnell S. E., Guinard J. X., Bamforth C. W., (2003) Journal of the American Society of Brewing Chemists 61:133-141.

Chapman J. (1988) Hop Products Contribution to Beer Flavour. Ferment, Vol. 1, No. 1, p. 22-26

De Cooman L., Aerts G., Van Opstaele F., Goiris K., Syryn E., De rouck G., De Ridder M., De Keukeleire D. (2004) New trends in advance hopping. Part 2: Application of varietal hop aromas. Cerevisia, 29.

De Cooman L., Aerts G., Overmeire H., De Keukeleire D. (2000) Journal of the Institute of Brewing, 106: 169-178.

Dedoussis G V, Kaliora A C, Andrikopoulos N K. 2005. Effect of phenols on natural killer (NK) cell-mediated death in the K562 human leukemic cell line. Cell Biol Int. 29:884-889.

De Keukeleire D. (2000) Fundamentals of beer and hop chemistry. Quimica Nova, 23: 108-112.

Delcour J. A., Vandenberghe M. M., Dondeyne P., Schrevens E. L., Wijnhoven J., Moerman E. (1984) Flavour and haze stability differences in unhopped and hopped all-malt Pilsner beers brewed with proanthocyanidin-free and with regular malt. Journal of the Institute of Brewing, 90, 67-72.

Delcour J. A., Schoeters M. M., Dondeyne P., Schrevens E. L., Wijnhoven, J., Moerman E. (1985) Flavour and haze stability differences due to hop and malt tannins in all-malt Pilsner beers brewed with proanthocyanidin-free and with regular malt. Journal of the Institute of Brewing. 91: 302-305.

Drawert Hg. F. (1980) Brautechn. Analysenmethoden, Selbstverlag der MEBAK, Band II, Freising-Weihenstephan, S, 327.

Everaert E. (1992), Bijdrage tot de studie van de biochemische RP-HPLC identificatie van hop (Humulus lupulus L.) en gerst (Hordeum vulgare L.) cultivars, PhD thesis, Ghent University, Ghent, Belgium

Forster A., Beck B., Schmidt R. (1995) Proceedings of the 25^{th} EBC Congress, Brussels, Fachverlag Hans Carl, Nürnberg, Germany.

Gerhauser C., Alt A., Heiss E., Gamal-Eldeen A., Klimo K., Knauft J., Neumann I., Scherf H.-R., Frank N., Bartsch H. Becker H. (2002) Cancer chemopreventive activity of xanthohumol, a natural product derived from hop, Molecular Cancer Therapeutics, 1: 959-969.

Goiris K., De ridder M., De Rouck G., Boeykens A., Van Opstaele F., Aerts G., De Cooman L., De Keukeleire D. (2002) The oxygenated sesquiterpenoid fraction of hops in relation to spicy hop character of beer. Journal of the Institute of Brewing. 108: 86-93.

Goldammer T. (2000) The brewer's handbook. The complete book to brewing beer. Apex publishers. ISBN: 0-967512-0-3.

Gromus J., Lustig, S. (2001) Influence of polyphenols and reducing substances on beer quality and their fate during beer production. Brauwelt International. 3: 208-213.

Institute of Brewing methods of analysis, volume 1, analytical (1997), Institute of Brewing, London, England

Kanadaswami C., Lee L. T., Lee P. P., Hwang J. J., Ke F. C., Huang Y. T., Lee M. T. (2005) The antitumor activities of flavonoids. In Vivo 19:895-909.

Kaltner D., Thum B., Forster C., Back W. (2001) Investigations into technological and flavour effects in beer. Brauwelt International, 1: 40-45.

Kaneda, H., Kobayashi, N., Furusho, S., Sahara, H., Koshino S. (1995) Reducing activity and flavor stability of beer. MBAA technical quarterly. 32: 90-94.

Langstaff S. A., Guinard J.-X., Lewis M. J. (1991) Instrumental evaluation of the mouthfeel of beer and correlation with sensory evaluation. Journal of the Institute of Brewing, 97: 427-433.

Langstaff S. A., Lewis M. J. (1993) Mouthfeel of beer: a review. Journal of the Institute of Brewing, 99: 31-37.

McMurrough I, Delcour J. A. (1994) Wort polyphenols. Ferment 7: 175-282.

McMurrough I., Madigan D., Kelly R. J., Smyth M. R. (1996) The role of flavanoid polyphenols in beer stability. J. Am. Soc. Brew. Chem. 54:141-148.

Moir M. (2000) J. Am. Soc Brew Chem, 58, 131:146

Molnar J, Beladi I, Domonkos K, Foldeak S, Boda K, Veckenstedt A. 1981 Antitumor activity of flavanoids on NK/Ly ascites tumor cells. Neoplasma. 28:11-18.

Mikyska A., Hrabak M., Haskova D., Srogl J. (2002) The role of malt and hop polyphenols in beer quality, flavour and haze stability. Journal of the Institute of Brewing, 108: 78-85.

Milligan S, Kalita J, Pocock V, Heyerick A, De Cooman L, Rong H, De Keukeleire D. 2002 Oestrogenic activity of the hop phyto-oestrogen, 8-prenylnaringenin. Reproduction. 123: 235-242.

Nakamura T., Franz O., Back W. (2003) Proceedings of the 29th EBC Congress, Dublin, Ireland, Fachverlag Hans Carl, Nürnberg Germany. Contribution 65, 9 pp.

Piendl A. (2002) Studies of polyphenols and hop bitter substances, Brauwelt International 20: 29-30.

Piendl A., Biendl M. (2000) Physiological significance of polyphenols and hop bitters in beer, Brauwelt International, 18: 310-317.

Raj Narayana K., Sripal Reddy M., Chaluvadi M. R., Krishna D. R. (2001) Bioflavonoids classification, pharmacological, biochemical effects and therapeutic potential, Indian Journal of Pharmacology, 33: 2-16

Stewart G. G. (2004) The chemistry of beer instability. Journal of Chemical Education. 81:963-968.

Urquiaga I, Leighton F (2000) Plant polyphenol antioxidants and oxidative stress. Biol Res. 33:55-64.

TABLE 1
Total polyphenol content and reducing power of hop polyphenol
extracts prepared under varying conditions

| | total polyphenol | | |
|---|---|---|---|
| | content | DPPH-value | ITT-value |
| extract | (mg/g pellets) | (ΔA_{10 min}/mg pellets) | (ΔA_{60 s}/g pellets) |
| A | 42 | 1.25 | 1.55 |
| B1 | 34 | 0.65 | 1.70 |
| B2 | 28 | 0.70 | 1.75 |
| C1 | 47 | 1.31 | 4.50 |
| C2 | 45 | 1.31 | 4.46 |
| D1 | 31 | 0.47 | 1.59 |
| D2 | 21 | 0.62 | 1.83 |
| E1 | 35 | 0.89 | 4.04 |
| E2 | 32 | 0.90 | 3.93 |

TABLE 2
Extraction yields of selected marker components of the
polyphenol extracts prepared under varying conditions

| | mg/g pellets extracted | | |
|---|---|---|---|
| extract | rutin | kaempferol-3-glucoside | xanthohumol |
| A | 1.20 | 0.88 | 0.44 |
| B1 | 0.79 | 0.56 | 0.98 |
| B2 | 0.68 | 0.49 | 1.01 |
| C1 | 1.14 | 0.82 | 2.02 |
| C2 | 1.13 | 0.80 | 1.97 |
| D1 | 1.07 | 0.75 | 1.86 |
| D2 | 1.01 | 0.70 | 1.45 |
| E1 | 1.12 | 0.77 | 2.34 |
| E2 | 1.18 | 0.73 | 2.37 |

TABLE 3
Reducing power and polyphenolic content of total hop polyphenol
extracts, originating from different hop products and prepared by
method C. The polyphenol content is expressed as mg polyphenols
per g hop product. The reducing power determined by DPPH
discoloration is expressed as the change in absorbance at 525 nm
over 10 minutes per mg hop product.

| | Polyphenol | Reducing |
|---|---|---|
| Hop product | content | power |
| Pellets T90 (cv Saaz) | 41.0 | 1.404 |
| Pellets T90 (cv Hersbrucker Spät) | 32.9 | 1.133 |
| Pellets T45 (cv Hersbrucker Spät) | 30.0 | 1.199 |
| Pellets T90 (cv Magnum) | 15.0 | 0.502 |
| Pellets T90 (cv East Kent Golding) | 39.0 | 1.141 |
| Commercial spent hops (cv Magnum) | 18.8 | 0.563 |
| In-house spent hops from T90 pellets | 19.4 | 0.697 |
| (cv Magnum) | | |
| In-house spent hops from T90 pellets | 37.0 | 1.276 |
| (cv Hersbrucker Spät) | | |
| In-house spent hops from T90 pellets (cv Saaz) | 43.2 | 1.283 |
| In-house spent hops from T90 pellets | 40.4 | 1.134 |
| (cv East Kent Golding) | | |
| Vegetative residue of pellets T45 | 41.2 | 1.299 |
| (cv Hallertau Select) | | |

TABLE 4
Content of selected marker polyphenolic components as determined by HPLC-UV
analysis in the total hop polyphenol extracts prepared by method C starting from different
hop products. The content of the different polyphenolic components is expressed as mg/100 g
hop product, except for procyanidin B3 and prodelphinidin B3, which are expressed in mg
per 100 g hop product as (+)-catechin equivalents.

| | | | p-coumaric | | | procyanidin | prodelphinidin |
|---|---|---|---|---|---|---|---|
| Hop product | xanthohumol | rutin | acid | ferulic acid | (+)-catechin | B3 | B3 |
| Pellets T90 (cv Saaz) | 264 | 117 | 2 | 10 | 341 | 192 | 3 |
| Pellets T90 (cv | 164 | 113 | 2 | 12 | 302 | 150 | 4 |
| Hersbrucker Spat) | | | | | | | |
| Pellets T45 (cv | 336 | 102 | 2 | 8 | 236 | 133 | 4 |
| Hersbrucker Spat) | | | | | | | |
| Pellets T90 (cv | 427 | 50 | 2 | 4 | 106 | 61 | 3 |
| Magnum) | | | | | | | |
| Pellets T90 (cv East | 315 | 85 | 3 | 10 | 247 | 115 | 15 |
| Kent Golding) | | | | | | | |
| Commercial spent | 533 | 66 | 4 | 6 | 106 | 47 | 8 |
| hops (cv Magnum) | | | | | | | |
| In-house spent hops | 592 | 65 | 2 | 6 | 123 | 74 | 5 |
| from T90 pellets (cv | | | | | | | |
| Magnum) | | | | | | | |
| In-house spent hops | 190 | 133 | 3 | 14 | 311 | 172 | 9 |
| from T90 pellets (cv | | | | | | | |
| Hersbrucker Spat) | | | | | | | |
| In-house spent hops | 313 | 128 | 2 | 13 | 365 | 200 | 17 |
| from T90 pellets (cv | | | | | | | |
| Saaz) | | | | | | | |
| In-house spent hops | 359 | 102 | 3 | 11 | 281 | 134 | 20 |
| from T90 pellets (cv | | | | | | | |
| East Kent Golding) | | | | | | | |
| Vegetative residue of | 58 | 118 | 2 | 9 | 415 | 232 | 4 |
| pellets T45 (cv | | | | | | | |
| Hallertau Select) | | | | | | | |

TABLE 5
Polyphenolic composition of a total hop polyphenol extract from spent hops cv Saaz
obtained with procedure C and with procedure F. Total polyphenol content was measured by
EBC method 9.9.1 (Analytica EBC, 1998) and marker polyphenolic components were
determined by HPLC-UV analysis.

| | Total hop polyphenol extract | | Total hop polyphenol extract | |
|---|---|---|---|---|
| | (method C) | | (method F) | |
| | | relative | | relative |
| | | composition of | content | composition of |
| | content | marker | (g/100 g dry | marker |
| | (g/100 g dry matter) | polyphenols (%) | matter) | polyphenols (%) |
| Total polyphenol content | 14.4 | / | 21.8 | / |
| procyanidin B3 | 1.02 | 17.2 | 0.90 | 17.7 |
| (+)-catechin | 2.06 | 34.9 | 1.75 | 34.6 |
| p-coumaric acid | 0.05 | 0.9 | 0.04 | 0.9 |
| ferulic acid | 0.02 | 0.3 | 0.02 | 0.4 |
| subtotal | 3.15 | 53.4 | 2.71 | 53.6 |
| rutin | 0.56 | 9.5 | 0.46 | 9.1 |
| quercetin derivative | 0.33 | 5.6 | 0.45 | 8.8 |
| kaempherol-3-glucoside | 0.33 | 5.5 | 0.26 | 5.1 |
| kaempherol derivative | 0.30 | 5.1 | 0.39 | 7.8 |
| subtotal | 1.51 | 25.7 | 1.56 | 30.8 |
| 8-prenyl naringenin | 0.04 | 0.7 | 0.02 | 0.3 |
| 6-prenyl naringenin | 0.10 | 1.7 | 0.04 | 0.9 |
| xanthohumol | 1.10 | 18.6 | 0.73 | 14.4 |
| subtotal | 1.24 | 21.0 | 0.79 | 15.6 |

TABLE 6
Polyphenol composition of a flavonol glycoside enriched
extract obtained from spent hops cv Saaz with method G.

| | relative composition |
|---|---|
| | of marker |
| | polyphenols (%) |
| procyanidin B3 | 20.3 |
| (+)-catechin | 34.8 |
| p-coumaric acid | 0.2 |
| ferulic acid | 0.9 |
| subtotal | 56.2 |
| rutin | 9.4 |
| quercetin derivative | 14.6 |
| kaempherol-3-glucoside | 4.7 |
| kaempherol derivative | 11.1 |
| subtotal | 39.8 |
| 8-prenyl naringenin | 0.1 |
| 6-prenyl naringenin | 0.1 |
| xanthohumol | 3.8 |
| subtotal | 4.0 |

TABLE 7
Relative distribution of the reducing power and polyphenolic
content after chromatographic fractionation by method H of
total hop polyphenol extract prepared from
pellets T90 cv Hersbrucker Sp\ddot{at}

| | reducing power | polyphenolic content |
|---|---|---|
| proanthocyanidins | 64% | 71% |
| flavonol glycosides | 28% | 25% |
| prenylated flavonoids | 8% | 4% |

TABLE 8
Relative distribution of marker components after chromatographic fractionation by
method H of total hop polyphenol extract prepared from pellets T90 cv Hersbrucker Spät

| | xanthohumol | rutin | p-coumaric acid | ferulic acid | (+)-catechin | procyanidin B3 | prodelphinidin B3 |
|---|---|---|---|---|---|---|---|
| proanthocyanidins | 0% | 0% | 0% | 18% | 82% | 87% | 85% |
| flavonol glycosides | 1% | 99% | 100% | 82% | 18% | 13% | 15% |
| prenylated flavonoids | 99% | 1% | 0% | 0% | 0% | 0% | 0% |

TABLE 9
Polyphenolic composition of a flavonol glycoside fraction cv Saaz obtained with
fractionation method H compared with the composition of an extract prepared with
fractionation method I. Total polyphenol content was measured by EBC method 9.9.1
(Analytica EBC, 1998) and marker polyphenolic components were determined by HPLC-UV
analysis.

| | flavonol glycoside fraction | | flavonol glycoside fraction | |
|---|---|---|---|---|
| | (method H) | | (method I) | |
| | | relative | | relative |
| | | composition of | | composition of |
| | content | marker | content | marker |
| | (g/100 g dry matter) | polyphenols (%) | (g/100 g dry matter) | polyphenols (%) |
| total polyphenol | 52.0 | | 49.7 | |
| procyanidin B3 | 1.32 | 2.6 | 1.64 | 3.4 |
| (+)-catechin | 6.23 | 12.1 | 6.13 | 12.7 |
| p-coumaric acid | 0.30 | 0.6 | 0.05 | 0.1 |
| ferulic acid | 1.13 | 2.2 | 0.39 | 0.8 |
| subtotal | 8.98 | 17.5 | 8.21 | 17.0 |
| rutin | 14.25 | 27.7 | 13.55 | 28.1 |
| quercetin derivative | 11.27 | 21.9 | 9.02 | 18.7 |
| kaempherol-3-glucoside | 7.61 | 14.8 | 9.03 | 18.7 |
| kaempherol derivative | 8.75 | 17.0 | 8.40 | 17.4 |
| subtotal | 41.88 | 81.4 | 40.00 | 82.9 |
| 8-prenyl naringenin | 0.49 | 0.9 | 0.03 | 0.06 |
| 6-prenyl naringenin | 0.08 | 0.2 | 0.01 | 0.03 |
| xanthohumol | 0.07 | 0.1 | 0.00 | 0.00 |
| subtotal | 0.64 | 1.2 | 0.04 | 0.09 |

TABLE 10
Sensory effects of the addition of total polyphenolic extracts prepared
by method C from different hop products added to pilsner beer bittered
solely with pre-isomerised hop acid extract. The sensory properties
bitterness intensity, fullness, astringency and stickiness were given a
score from 1 (very weak) to 5 (very strong). Values represent the
mean scores for all 17 panelists.

| | | pellets T90 | | |
|---|---|---|---|---|
| | pellets T90 | Hersbrucker | pellets T90 | spent hops |
| | Saaz | Spät | Magnum | Magnum |
| bitterness | 3.1 | 3.1 | 3.1 | 3.2 |
| fullness | 2.8 | 3.2 | 2.8 | 2.8 |
| astringency | 2.7 | 2.8 | 3.3 | 3.3 |
| stickiness | 2.1 | 2.3 | 2.3 | 2.2 |

TABLE 11
Sensory effects of the addition of polyphenolic fractions derived
from total hop polyphenol extract by method H to pilsner beer
bittered solely with isomerised hop acid extract. The sensory
properties bitterness intensity, fullness, astringency and
stickiness were given a score from 1 (very weak) to 5 (very strong).
Values represent the mean scores for all 17 panelists.

| | mean intensity score | | |
|---|---|---|---|
| | | flavonol | prenylated |
| | proanthocyanidins | glycosides | flavonoids |
| bitterness | 2.9 | 2.9 | 2.7 |
| fullness | 2.2 | 2.9 | 2.6 |
| astringency | 3.3 | 2.1 | 2.4 |
| stickiness | 1.8 | 2.0 | 1.9 |

TABLE 12
Sensory effects of the addition of total polyphenolic extract isolated
from cv Saaz by method F to top fermented beer bittered solely
with pre-isomerised hop acid extract. The sensory properties
bitterness intensity, fullness, astringency and stickiness were
given a score from 1 (very weak) to 5 (very strong). Values
represent the mean scores for all 15 panelists.

| | | addition of | addition of |
|---|---|---|---|
| | reference beer | 10 mg/l hop | 20 mg/l hop |
| | no hop polyphenols | polyphenols | polyphenols |
| bitterness | 2.8 | 3.2 | 3.7 |
| fullness | 2.9 | 3.2 | 3.5 |
| astringency | 2.3 | 2.3 | 2.6 |
| stickiness | 2.3 | 1.9 | 1.8 |

TABLE 13
Sensory effects of the addition of flavonol glycosides isolated from
cv Saaz by method I to top fermented beer bittered solely with
pre-isomerised hop acid extract. The sensory properties bitterness
intensity, fullness, astringency and stickiness were given a score
from 1 (very weak) to 5 (very strong). Values represent the mean
scores for all 15 panelists.

| | reference beer | addition of 2 mg/l |
|---|---|---|
| | no flavonol glycosides | flavonol glycosides |
| bitterness | 2.8 | 3.0 |
| fullness | 2.9 | 3.7 |
| astringency | 2.3 | 2.5 |
| stickiness | 2.3 | 2.5 |

TABLE 14
Sensory effects of combinations of 10 mg/l total hop polyphenol extract with
different types of hop essential oils (10 μg/l spicy hop essence, 20 μg/l floral hop essence,
and 10 μg/l dry hop essence).

| | mean score | | | | | | | |
|---|---|---|---|---|---|---|---|---|
| Hop essence type | none | none | Spicy | Spicy | Floral | Floral | Dry hop | Dry hop |
| Hop polyphenol fraction | none | Total | none | Total | none | Total | none | Total |
| | | polyphenol | | polyphenol | | polyphenol | | polyphenol |
| Hoppy smell intensity | 1.6 | 1.9 | 2.7 | 2.7 | 2.7 | 2.8 | 2.8 | 2.9 |
| Hoppy smell quality | 2.4 | 2.4 | 2.4 | 2.9 | 2.9 | 3.2 | 3.0 | 2.8 |
| Hop aroma intensity | 1.5 | 2.0 | 2.8 | 2.7 | 3.0 | 2.9 | 2.9 | 3.0 |
| Hop aroma quality | 1.8 | 2.3 | 2.7 | 2.9 | 2.8 | 2.9 | 2.9 | 3.1 |
| Bitterness intensity | 2.2 | 3.0 | 3.0 | 3.2 | 2.9 | 2.9 | 3.0 | 3.4 |
| Fullness | 2.3 | 2.9 | 2.8 | 3.4 | 2.5 | 3.3 | 2.9 | 3.3 |
| Astringency | 1.7 | 2.5 | 2.4 | 2.9 | 2.4 | 2.5 | 2.6 | 2.8 |
| Stickiness | 1.8 | 2.1 | 2.0 | 2.4 | 2.1 | 1.9 | 2.3 | 2.3 |

Additions were made to pilsner beer bittered solely with pre-isomerised hop acid extract. The sensory properties hoppy smell intensity, hop aroma intensity, bitterness intensity, fullness, astringency and stickiness were given a score from 1 (very weak) to 5 (very strong), and hoppy smell quality and hop aroma quality were given a score from 1 (very unpleasant) to 5 (very pleasant). Values represent the mean scores for all 18 panelists.

TABLE 15
Sensory effects of combinations of 1 mg/l hop flavonol glycoside extract with
different types of hop essential oils (10 μg/l spicy hop essence, 20 μg/l floral hop essence,
and 10 μg/l dry hop essence).

| | mean score | | | | | | | |
|---|---|---|---|---|---|---|---|---|
| Hop essence type | none | none | Spicy | Spicy | Floral | Floral | Dry hop | Dry hop |
| Hop polyphenol fraction | none | Flavonol | none | Flavonol | none | Flavonol | none | Flavonol |
| | | glycoside | | glycoside | | glycoside | | glycoside |
| Hoppy smell intensity | 1.7 | 2.0 | 2.8 | 2.8 | 2.9 | 3.0 | 2.8 | 3.0 |
| Hoppy smell quality | 2.1 | 2.6 | 2.5 | 2.8 | 3.0 | 3.1 | 3.0 | 3.1 |
| Hop aroma intensity | 1.6 | 1.8 | 2.9 | 2.9 | 2.8 | 3.1 | 2.9 | 3.1 |
| Hop aroma quality | 2.0 | 2.1 | 2.6 | 2.7 | 2.9 | 3.0 | 3.1 | 3.2 |
| Bitterness intensity | 2.3 | 2.8 | 2.8 | 3.0 | 2.8 | 3.1 | 3.0 | 3.3 |
| Fullness | 2.3 | 3.1 | 2.7 | 3.1 | 2.8 | 3.8 | 2.8 | 3.6 |
| Astringency | 1.9 | 2.6 | 2.1 | 2.7 | 2.0 | 2.4 | 2.3 | 2.7 |
| Stickiness | 1.8 | 1.9 | 1.8 | 2.1 | 1.9 | 2.3 | 2.1 | 2.6 |

Additions were made to pilsner beer bittered solely with pre-isomerised hop acid extract. The sensory properties hoppy smell intensity, hop aroma intensity, bitterness intensity, fullness, astringency and stickiness were given a score from 1 (very weak) to 5 (very strong), and hoppy smell quality and hop aroma quality were given a score from 1 (very unpleasant) to 5 (very pleasant). Values represent the mean scores for all 18 panelists.

TABLE 16
Standard physical and biochemical parameters of the different experimental beers
A1, A2, B1, B2, C1, C2, D1, and D2 prepared as described in the Materials and Methods of
Example 3.

| | unit | A1 | A2 | B1 | B2 | C1 | C2 | D1 | D2 |
|---|---|---|---|---|---|---|---|---|---|
| alcohol content | ml/100 ml | 5.26 | 5.42 | 5.77 | 5.77 | 5.67 | 6.06 | 5.42 | 5.82 |
| apparent extract | g/100 g | 2.17 | 1.82 | 1.98 | 1.91 | 2.00 | 2.13 | 1.93 | 1.70 |
| real extract | g/100 g | 4.07 | 3.78 | 4.06 | 3.99 | 4.05 | 4.30 | 3.89 | 3.79 |
| original gravity | °P | 12.06 | 12.03 | 12.78 | 12.72 | 12.64 | 13.20 | 12.13 | 12.62 |
| apparent degree | % | 82.01 | 84.85 | 84.56 | 85.00 | 84.14 | 84.18 | 84.13 | 86.55 |
| fermentation | | | | | | | | | |
| real degree fermentation | % | 67.65 | 69.91 | 69.78 | 70.12 | 69.43 | 69.57 | 69.38 | 71.35 |
| density | g/cm³ | 1.0067 | 1.0053 | 1.0059 | 1.0056 | 1.0060 | 1.0065 | 1.0057 | 1.0048 |
| FAN (pitching wort) | mg/l | 202.1 | 206.3 | 223.3 | 241.4 | 229.5 | 242.38 | 173.2 | 171.5 |
| FAN (finished beer) | mg/l | 138.3 | 125.8 | 147.4 | 123.9 | 114.4 | 150.4 | 107.9 | 135.5 |
| pH | | 4.50 | 4.41 | 4.51 | 4.50 | 4.46 | 4.58 | 4.48 | 4.45 |
| colour | EBC | 5.4 | 5.4 | 6.3 | 6.1 | 6.2 | 6.1 | 5.6 | 5.5 |
| bitterness (HPLC) | ppm | 26.78 | 18.09 | 21.85 | 19.25 | 20.4 | 19.9 | 21.30 | 27.50 |
| total polyphenol content | mg/l | 143.9 | 165.6 | 191.1 | 203.4 | 165.1 | 192.4 | 197.6 | 190.0 |
| total flavanoid content | mg/l | 36.2 | 38.2 | 43.0 | 48.6 | 35.3 | 39.6 | 40.3 | 37.5 |
| soluble protein | mg/l | 291 | 288 | 336 | 351 | 246 | 245 | 285 | 217 |
| sensitive protein | FHU | 9.13 | 8.61 | 7.93 | 8.68 | 9.49 | 8.21 | 8.20 | 7.76 |
| vicinal diketones | mg/l | 0.091 | 0.028 | 0.049 | 0.040 | 0.080 | 0.100 | 0.116 | 0.100 |
| foam stability (Nibem) | s | 229 | 223 | 233 | 242 | 245 | 244 | 272 | 227 |
| DPPH | ΔA_{(10 min)} | 1.019 | 1.031 | 1.103 | 1.137 | 1.065 | 1.192 | 1.064 | 1.048 |
| dissolved oxygen | ppb | 28 | 33 | 26 | 28 | 38 | 25 | 62 | 37 |

TABLE 17
Content of selected marker polyphenolic components, as determined by
HPLC-UV analysis, in the experimental beers A1, A2, B1, B2, C1, C2, D1,
and D2 prepared as described in the Materials and Methods of Example 3.
The contents of the different polyphenolic components is expressed as
mg/l beer, except for procyanidin B3 and prodelphinidin B3, which are
expressed as mg of (+)-catechin equivalents per litre beer.

| | A1 | A2 | B1 | B2 | C1 | C2 | D1 | D2 |
|---|---|---|---|---|---|---|---|---|
| | concentration (mg/l) | | | | | | | |
| prodelphinidin trimer | 0.63 | 0.36 | 0.69 | 0.59 | 0.54 | 1.43 | 1.95 | 1.44 |
| prodelphinidin B3 | 3.73 | 2.17 | 3.56 | 4.20 | 2.96 | 5.97 | 5.30 | 4.37 |
| procyanidin trimer | 1.76 | 1.07 | 2.01 | 2.07 | 1.53 | 2.82 | 2.50 | 2.15 |
| procyanidin B3 | 5.64 | 3.73 | 5.51 | 6.82 | 3.76 | 6.78 | 6.89 | 5.98 |
| (+)-catechin | 5.07 | 3.96 | 5.46 | 7.07 | 2.79 | 5.47 | 6.03 | 6.89 |
| (−)-epicatechin | 1.19 | 0.80 | 1.15 | 1.15 | 0.37 | 0.90 | 1.14 | 1.01 |
| p-coumaric acid | 1.19 | 0.69 | 1.02 | 1.07 | 0.67 | 1.09 | 1.10 | 1.14 |
| ferulic acid | 2.24 | 1.27 | 1.89 | 1.94 | 1.17 | 1.88 | 2.09 | 2.11 |
| rutin | — | 1.12 | 1.12 | 2.35 | — | 1.51 | 1.17 | 2.44 |
| isoxanthohumol | — | 0.20 | 0.16 | 0.23 | — | 0.25 | 0.06 | 0.37 |
| 8-prenyl naringenin | — | 0.02 | 0.01 | 0.01 | — | 0.01 | 0.01 | 0.02 |
| 6-prenyl naringenin | — | 0.04 | 0.02 | 0.01 | — | 0.01 | 0.01 | 0.03 |
| xanthohumol | tr. | 0.38 | 0.31 | 0.14 | — | <0.01 | 0.01 | <0.01 |

TABLE 18
Hydroxy fatty acids content in pitching wort of beers C1, C2, D1, and
D2 prepared as described in the Materials and Methods of Example 3.

| Beer | DHOE (mg/l) | THOE (mg/l) |
|---|---|---|
| C1 | 2.7 | 14.3 |
| C2 | 2.5 | 11.5 |
| D1 | 2.4 | 8.7 |
| D2 | 1.6 | 6.5 |

TABLE 19
Nitrate content of beers A1, A2, B1, B2, prepared as described in the Materials and
Methods of Example 3, compared to other experimental beers prepared with other hopping
regimes.

| | | | | | Nitrate content |
|---|---|---|---|---|---|
| Beer | Hopping | Point of addition | addition rate | | (mg/l) |
| A1 | Iso-α-acid extract | end boiling | 17.6 | ml/hl | 3.4 |
| A2 | total polyphenolic extract Saaz | start boiling | 50.0 | mg/l | 12.4 |
| | Iso-α-acid extract | end boiling | 17.6 | ml/hl | |
| B1 | total polyphenolic extract Saaz | brewing and sparging liquor | 50.0 | mg/l | 11.0 |
| | Iso-α-acid extract | end boiling | 17.6 | ml/hl | |
| B2 | total polyphenolic extract Saaz | brewing and sparging liquor | 50.0 | mg/l | 19.6 |
| | total polyphenolic extract Saaz | start boiling | 50.0 | mg/l | |
| | Iso-α-acid extract | end boiling | 17.6 | ml/hl | |
| | Iso-α-acid extract | end boiling | 16.2 | ml/hl | 14.8 |
| | Dry hopping pellets H. Spät T90 | onset maturation | 130.0 | g/hl | |
| | Magnum pellets | start boiling | 56.3 | g/hl | 7.8 |
| | Hersbrucker Spät T90 pellets | start boiling | 321.8 | g/hl | 33.0 |
| | Iso-α-acid extract | end boiling | 12.5 | ml/hl | 28.6 |
| | Hersbrucker Spät T90 pellets | whirlpool | 261.4 | g/hl | |
| | Iso-α-acid extract | end boiling | 12.5 | ml/hl | 12.8 |
| | Hersbrucker Spät T45 pellets | whirlpool | 119.9 | g/hl | |
| | Iso-α-acid extract | end boiling | 18.7 | ml/hl | 4.6 |
| | CO₂-extract Magnum | start boiling | 13.3 | g/hl | 3.4 |
| | Iso-α-acid extract | end boiling | 17.6 | ml/hl | 7.0 |
| | total polyphenolic extract Saaz | onset maturation | 20.0 | mg/l | |
| | Iso-α-acid extract | end boiling | 17.6 | ml/hl | 3.4 |
| | flavonol glycoside fraction Saaz | onset maturation | 10.0 | mg/l | |
| | Iso-α-acid extract | end boiling | 17.6 | ml/hl | 3.6 |
| | Prenyl. flavanoid fraction Saaz | onset maturation | 10.0 | mg/l | |

TABLE 20
Sensory effects of the addition of hop aromatic oil fractions to beer B1,
prepared with addition of total hop polyphenol extract as described in
the Materials and Methods of Example 3. The reference beer A1, without
hop polyphenol extract, was prepared as described in the Materials and
Methods of Example 3. The hop essences were added to finished beer at
20 μg/l for floral hop essence, 10 μg/l for spicy hop essence and 10 μg/l
for dry hop essence. The sensory properties bitterness intensity, fullness,
astringency and stickiness were given a score from 1 (very weak) to
5 (very strong). Values represent the mean scores for all 20 panelists.

| | bitterness | | | |
|---|---|---|---|---|
| Beer | intensity | fullness | astringency | stickiness |
| A1 | 2.8 | 2.3 | 2.2 | 1.9 |
| B1 | 3.3 | 3.1 | 2.8 | 2.3 |
| B1 + floral hop essence | 2.9 | 3.0 | 2.7 | 2.3 |
| B1 + spicy hop essence | 3.0 | 2.8 | 3.1 | 2.0 |
| B1 + dry hop essence | 3.1 | 3.1 | 3.4 | 2.3 |

TABLE 21
Mean sensory ranking scores for preference of different beers based on
beer B1, prepared with addition of total hop polyphenol extract as
described in the Materials and Methods of Example 3, to which different
hop essences were added. The hop essences were added to the finished
beer B1 at 20 μg/l for floral hop essence, 10 μg/l for spicy hop essence
and 10 μg/l for dry hop essence. The reference beer A1, without hop
polyphenol extract, was prepared as described in the Materials and
Methods of Example 3. Sensory evaluation was performed with a trained
panel of 20 persons. Ranking scores ranged from 1 (least preferred) to
5 (most preferred). Data marked with a different letter are significantly
different from each other according to Friedman's rank sum
test at p < 0.001.

| | Mean ranking |
|---|---|
| Beer | score |
| A1 | 2.30 a |
| B1 | 2.95 ab |
| B1 + floral hop essence | 2.95 ab |
| B1 + spicy hop essence | 2.95 ab |
| B1 + dry hop essence | 3.85 b |

All publications and patents mentioned in this specification are herein incorporated by reference to the same extent as if each individual publication or patent was specifically and individually indicated to be incorporated by reference.

What is claimed is:

1. A brewing additive extracted from hop wherein the dry matter of said additive comprises at least 15% (w:w) flavonol glycosides.

2. The brewing additive according to claim 1 wherein the dry matter comprises at least 30% (w:w) flavonol glycosides.

3. A brewing additive according to claim 1 wherein the dry matter of said additive comprises at least 5% (w:w) rutin.

4. A brewing method comprising the addition of a brewing additive according to claim 1 wherein said brewing additive is added to the beer in the course of the brewing process.

5. The method according to claim 4 wherein the said brewing additive is added during the post-fermentation processing.

6. The method according to claim 4 wherein the said brewing additive is added during mashing, lautering, wort boiling, wort clarification, wort cooling, wort inoculation or fermentation.

7. The method according to claim 6 wherein the said brewing additive is added at the onset of mashing.

8. The method according to claim 7 wherein said additive is added to the brewing liquor used for mashing-in and sparging.

9. The method according to claim 4 wherein the addition of the said brewing additive corresponds with the addition of 0.5 to 200 mg hop polyphenols per liter finished beer.

10. The method according to claims 4 wherein said method further comprises the addition of an isolated hop extract enriched in hop alpha acids.

11. The method according to claim 10 wherein 5 to 125 mg isomerised hop alpha acids are added per liter finished beer.

12. The method according to claim 10 wherein said hop alpha acids are added prior to or during wort boiling.

13. The method according to claim 4 wherein said method further comprises the addition of a hop essential oil extract.

14. The method according to claim 13 wherein 1 to 5000 μg essential hop oil components are added per liter finished beer.

15. The method according to claim 4 wherein the beer comprises less than 3.5% (v/v) alcohol.

16. The method according to claim 4 wherein the beer comprises less than 3 g real extract per 100 ml.

17. A method for the production of a brewing additive according to claim 1 comprising the extraction of hop material with an aqueous ethanol solvent having an ethanol to water ratio lower than 20:1 (v/v).

18. The method according to claim 17 wherein the ethanol to water ratio is higher than 1:10 (v/v).

19. The method according to claim 17 wherein the ratio of hop material to the aqueous ethanol solvent is 1:1 to 1:200 (w/v).

20. The method according to claim 17 wherein the aqueous ethanol extract is counter-extracted with a non-polar solvent with retention of the aqueous phase.

21. A brewing method comprising the addition of a hop extract comprising hop polyphenols at the onset of mashing.

22. The method according to claim 21 wherein the hop polyphenols are added to the brewing liquor used for mashing-in and sparging.

23. The method according to claim 21 comprising the addition of a hop extract wherein the dry matter of said extract comprises at least 15% (w:w) hop polyphenols.

24. The method according to claim 21 wherein the addition of the said hop extract corresponds with the addition of 0.5 to 200 mg hop polyphenols per liter finished beer.
